(19) United States
(12) Patent Application Publication
(10) Pub. No.: US 2002/0186679 A1
(43) Pub. Date: Dec. 12, 2002

(54) Mobile node supporting router

(76) Inventors: Keiichi Nakatsugawa, Kanagawa (JP); Hideaki Ono, Kanagawa (JP); Ryuichi Takechi, Kanagawa (JP); Kazuyuki Oka, Kanagawa (JP)

Correspondence Address: KATTEN MUCHIN ZAVIS ROSENMAN, 575 MADISON AVENUE, NEW YORK, NY, 10022-2585, US

(21) Appl. No.: 10/015,372

(22) Filed: Dec. 12, 2001

(30) Foreign Application Priority Data
Jun. 11, 2001 (JP) 2001-175933

(51) Int. Cl. H04J 3/24

(52) U.S. Cl. 370/349; 370/476

(57) ABSTRACT

In a mobile node supporting router connected to a network on which a Mobile IPv4/v6 operates, an encapsulating cache stores binding information of a mobile node, and a processor encapsulates a packet addressed to the mobile node with a care-of address included in the binding information at a foreign link interface. Also, the processor receives a binding demand packet from the mobile node, and stores the binding information included in the binding demand packet in the encapsulating cache. Furthermore, the processor of the foreign link interface exchanges mobile IP messages instead of a home agent of the mobile node, and the cache stores the binding information of the mobile node included in the message.

### BACKGROUND OF THE INVENTION

1. Field of the Invention

The present invention relates to a mobile node supporting router, and in particular to a mobile node supporting router connected to a network on which a Mobile IPv4/v6 operates.

As a protocol enabling a node to communicate in an IP network even if a connecting location on the network is changed, a Mobile IPv4 is standardized in a document RFC2002 in a standardization group IETF (Internet Engineering Task Force) in the United States.

Also, with a recent rapid increase in the number of nodes existing on the IP network, IP address exhaustion problem has become serious. In order to solve this problem, the IPv6 enabling more IP addresses to be used is standardized in a document RFC2460, and a shift to a network using the IP addresses is taking off.

Thus, the standardization of not only the mobile IP on the general IPv4 network but also the Mobile IPv6 is important as a protocol which supports a move of the node on the IPv6 network, so that the IETF Mobile IP Working Group has deliberated on standardizing the IPv6 in the RFC to prepare Draft Standard (see the document draft-ietf-mobileip-ipv6-13.txt).

2. Description of the Related Art

A packet transfer in the Mobile IPv6 based on the above-mentioned Draft Standard will now be described. It is to be noted that since the contents of standardization in the Mobile IPv4 and IPv6 are the same, the description of the Mobile IPv4 will be hereby omitted.

FIG. 26 shows a general Internet network, in which routers 110 and 120 are connected with a link 250, and routers 110 and 130 are connected with a link 240. Links 210, 220, and 230 are respectively connected to the routers 110, 120 and 130. A mobile node 300 is connected to the link 210. A mobile or fixed node (host) 310 is connected to the link 230.

The IP addresses (subnet prefix) of the links 210, 220, 230, 240, and 250 are respectively “10.x”, “20.x”, “30.x”, “40.x”, and “50.x”. The IP addresses of the nodes 300 and 310 are respectively “10.10” and “30.11”.

In the Mobile IPv6, e.g. the link 210 to which the node 300 is usually connected is referred to as a home link or a home network of the node 300, and the IP address “10.10” of the node 300 is referred to as a home address of the node 300.

On the home link 210, there exists a home agent which supports the moving of the node 300. While a home agent 11 exists within the router 110 on the home link 210 in FIG. 26, the home agent 11 does not necessarily exist in the router, and a server on the home link 210, for example, may function as a home agent.

Also, the links 220-250 except the home link 210 are referred to as foreign links of the mobile node 300.

(1) Location Registration of Mobile Node

When moving from the home link 210 to the foreign link, the node 300 acquires or generates a Care-of Address (hereinafter, occasionally abbreviated as CoA) which is an effective address at a moving destination in the foreign link, transmits a binding update (hereinafter, occasionally referred to as binding demand packet) to the home agent, and registers the CoA. It is to be noted that the binding update corresponds to a registration request message in the Mobile IPv4.

The home agent which has received the binding update generates a binding cache 14 for storing the home address, the CoA, and the registration lifetime of the node 300.

Hereinafter, the operation procedure of the location registration of the mobile node in this IPv6 will be more specifically described.

\mathring{1} The node 300 (home address=10.10) moves from the home link 210 to the foreign link 220.

\mathring{2} The node 300 detects, from the contents of a router advertisement message transmitted by the router 120 on the link 220, that the connecting link has changed, and generates an effective CoA (“20.10” in this case) on the link 220.

\mathring{3} The node 300 transmits the binding update to the home agent 11 (within the router 110 in this case) which manages the link 210 to register the CoA.

\mathring{4} The home agent 11 generates the binding cache 14 for the node 300 based on the binding update from the node 300.

It is to be noted that a registration lifetime is set in the binding cache 14 but is cleared after a lapse of the lifetime.

\mathring{5} Furthermore, the home agent 11 returns a binding acknowledgement (hereinafter, occasionally referred to as binding reply packet) to the node 300 as a reply. The node 300 receives the binding acknowledgement to recognize that the registration has been completed.

It is to be noted that the binding acknowledgement corresponds to a registration reply message in the Mobile IPv4.

Thereafter, while communicating on the link 220, the node 300 periodically transmits the binding update, in the same way as above \mathring{3}, to the home agent in order to hold the binding cache 14 in the home agent 11.

The home agent 11 updates the binding cache 14 and its lifetime.

(2) Transfer of Mobile Node-Addressed Packet

FIG. 27 shows an example of a packet transfer in the Mobile IPv6. This example shows an operation in which the router 110 transfers a packet addressed to the home address “10.10” of the node 300, transmitted by the node 310 when the binding cache 14 of the mobile node 300 is effective by the above-mentioned location registration. This operation will now be described.

\mathring{1} The node 310 on the link 230 transmits a packet 71 addressed to the home address “10.10” of the node 300.

\mathring{2} The home agent (router 110) 11 receives the packet 71, and retrieves the binding cache 14 based on the destination address “10.10” of this packet 71.

Since the binding cache 14 of the node 300 is registered, the home agent receives the packet instead of the node 300.

\mathring{3} The home agent 11 encapsulates the packet 71 based on the CoA “20.10” of the node 300 registered in the binding cache 14, and then transmits an encapsulated packet 72 whose destination address (CoA)=“20.10” to the node 300. This packet 72 is received by the node 300, which has moved to the link 220, to be decapsulated.

Thus, in case the packet is transmitted to the node which has moved to the foreign link in the Mobile IPv6, an encapsulation process at the home agent 11 is required. For this reason, in case the node which has moved communicates with many counterparts and communicates at a high speed, there is a problem that the load of the encapsulation process at the home agent 11 is increased.

Also, in the presence of numerous nodes to be supported by the home agent 11, in case many of them have moved, there is a problem that the load of processing binding updates transmitted from the nodes is increased.

In order to handle these problems, in the Mobile IPv6, when the node 300 which has moved to the foreign link 220 receives the capsulated packet 72 transferred from the home agent 11 for example, there is defined a route optimizing function of transmitting the binding update to the source node 310 of the packet 72, generating the binding cache at the source node 310 in the same way as the home agent, and directly transmitting subsequent packets 71 to the CoA of the node 300.

If this route optimizing function is effected, none of the packet 71 addressed to the node 300 is encapsulated at the home agent 11. However, the transmission of the binding update from the node 300 to the source node 310 is not always performed but depends on the setting of the node 300.

Also, even if the binding update is transmitted from the node 300 to the source node 310, the source node 310 does not always have a function of properly receiving the binding update, generating the binding cache, and directly transferring the packet 71 to the CoA of the node 300.

In these cases, the packet 71 addressed to the node 300 is transmitted to the home address of the node 300, and encapsulated at the home agent 11 for the transfer.

Also, in the Mobile IPv4, the route optimizing function itself is not perfectly defined, and is under review in the above-mentioned document draft-ietf-mobileip-optim-10.txt.

(3) Arrangement of Router

FIG. 28 shows an arrangement of the prior art router 110 in which the home agent shown in FIG. 26 is built. This router 110 is composed of link interfaces 10_1-10_3 (hereinafter, occasionally represented by a reference numeral 10) and a router core 20 connected to the interfaces 10. This router core is composed of a packet switch 21 connected to the interfaces 10_1-10_3 with packet transferring buses 30_1-30_3 (hereinafter, occasionally represented by a reference numeral 30) and a controller 22 connected to the packet switch 21.

The interface 10_1 includes the home agent 11 including the binding cache 14, and is connected to the home link 210 of the mobile node 300. The interface 10_2 is connected to the router 120 through the foreign link 250, and the interface 10_3 is connected to the router 130 through the foreign link 240 (see FIG. 26).

The controller 22 has a routing processor 23, which holds a routing table 24. It is to be noted that the controller 22 and the interface 10 are generally connected with a controlling bus 31, so that a control signal or the like is exchanged between the controller 22 and the interface 10 through the controlling bus 31.

Hereinafter, basic operations of function blocks will be described.

Link interface 10 has a line interface (not shown) for the connection to another router or network element. This interface 10 receives a packet transmitted from the other router or network element, provides the packet to the packet switch 21, and conversely outputs a transmission packet inputted from the packet switch 21 to the other router or network element.

The link interface 10 usually has a shape of card. The router 110 is equipped with link interfaces 10 of classifications and numbers corresponding to the classification and the arrangement of the connected links.

Home agent 11 is a home agent corresponding to the Mobile IPv6 (or Mobile IPv4). When the node 300 on the supporting home link 210 (see FIG. 26) has moved to the foreign link, the home agent 11 exchanges the Mobile IPv6 messages (binding demand packets, binding reply packets, and the like) with the node 300, generates/holds the binding cache 14 for the node 300, receives the packet 71 transmitted to the home address of the node 300 instead of the node 300, and transfers it to the CoA of the node 300 after encapsulation.

It is considered that the home agent 11 is actually realized in the form of a home agent function added to the link interface like the link interface 10_1 shown in FIG. 29. Thus, it becomes possible to support a move by the Mobile IPv6 of a node on the link only by changing the link interface 10_1 of the router 110, without additionally setting the home agent on the existing link 210.

Packet switch 21 distributes the packets inputted from the link interface 10 to the link interface (output interface) 10 determined by a routing process.

Controller 22 performs a control of the entire router 110 including the equipped link interface 10 such as an operation monitor of component hardwares, and a control of a software/hardware operation based on a setting of a maintenance person.

Routing processor 23 mainly prepares the routing table 24 by the setting of the maintenance person or a routing protocol, and performs the routing process of determining the interface 10 which outputs the packet inputted to the packet switch 21 based on the routing table 24.

(4) Operation of Location Registration Within Router

FIG. 29 shows an internal operation of the prior art router 110 in the operation of the location registration shown in FIG. 26. The operation of the location registration in the router 110 will be described referring to FIG. 26.

In FIG. 26, the node 300 which has moved to the link 220 transmits a binding demand packet 81 to the router 110 through the router 120 and the link 250.

FIG. 30A shows a binding demand packet (hereinafter, occasionally abbreviated as BU packet) 81, which is composed of an IP header 81a, a binding update option 81b, a home address option 81c, and an authentication header 81d.

The IP header 81a is composed of a destination address (address “10.1” of the home agent 11) and a source address (CoA=“20.10” of the node 300). The option 81b is composed of a sequence No. and a lifetime, etc. The option 81c is composed of the home address “10.10” of the node 300, and the authentication header 81d is composed of authentication data, etc.

\mathring{1} In the router 110 of FIG. 29, the interface 10_2 provides the received BU packet 81 to the packet switch 21.

\mathring{2} The routing processor 23 retrieves the routing table 24 based on the destination address (home agent address=“10.1”) of the BU packet 81 to determine the interface 10_1 as a destination interface.

FIG. 31 shows an example of a routing table 24, which is composed of a destination prefix, a next hop router, the number of hops, and an output interface.

The routing processor 23 retrieves the destination prefix “10.x”, where x indicates “don't care”, corresponding to the destination address=“10.1” to determine the output interface 10_1 based on the prefix (see 24a in FIG. 31).

\mathring{3} The packet switch 21 provides the BU packet 81 to the interface 10_1.

\mathring{4} At the interface 10_1, the home agent 11 checks the destination address of the BU packet 81, so that since the destination address is its address of the home agent 11, it receives the BU packet 81.

The home agent 11 analyzes the contents of the BU packet 81. In the absence of the binding information for the node 300 in the binding cache 14 (see FIG. 28), the home agent 11 generates the binding information for the node 300, and otherwise updates the information of the binding cache 14.

FIG. 30B shows an arrangement of the binding cache 14. This example especially shows a binding information example of the node 300. This binding information is composed of the home address=“10.10” of the mobile node 300, the home agent (HA) 11 address=“10.1” of the node 300, the CoA=“20.10” of the node 300, the registration lifetime=“300 (sec)”, and security information.

\mathring{5} The home agent 11 generates a binding reply packet (hereinafter, occasionally abbreviated as BA packet) 82 as a reply to the BU packet 81 to be inputted to the packet switch 21 for the return to the node 300.

FIG. 30C shows an arrangement of the BA packet 82, which is composed of an IP header 82a, a routing header 82b, a binding acknowledgment option 82c, and an authentication header 82d.

The IP header 82a is composed of the CoA=“20.10” of the node 300 which is a destination address 82_1 and the home agent address=“10.1” which is a source address 82_2. A home address 82_3=“10.10” of the node 300 is inserted into the routing header 82b. A sequence No. and a lifetime, etc. 82_4 are inserted into the option 82c, and authentication data, etc. 82_5 are inserted into the authentication header 82d.

\mathring{6} The routing processor 23 retrieves the routing table 24 based on the destination address=“20.10” of the BA packet 82 to determine the interface 10_2 for the interface to be outputted (see 24b in FIG. 31).

\mathring{7} The packet switch 21 outputs the BA packet 82 to the interface 10_2, which transmits the BA packet 82 to the router 120.

(5) Operation of Packet Transfer Within Router

FIG. 32 shows an example of a packet transfer process within the router 110 in the packet transfer example shown in FIG. 27. This packet transfer process will now be described.

The packet 71 transmitted by the node 310 is transmitted to the router 110 through the router 130 and the link 240 (see FIG. 27).

FIG. 33A shows an arrangement of the packet 71. This packet 71 is composed of an IP header 71a and a payload 71b. The IP header 71a is composed of the home address=“10.10” of the node 300 which is a destination address 71_1 and the address=“30.11” of the node 310 which is a source address 71_2.

\mathring{1} In the router 110 of FIG. 32, the interface 10_3 receives the packet 71, which is inputted to the packet switch 21.

\mathring{2} The routing processor 23 retrieves the routing table 24 (see 24a in FIG. 31) based on the destination address=“10.10” of the packet 71 to determine the interface 10_1 for the interface to be outputted.

\mathring{3} The packet switch 21 provides the packet 71 to the interface 10_1.

\mathring{4} At the interface 10_1, the home agent 11 retrieves whether or not the binding information corresponding to the destination address=“10.10” of the packet 71 exists. Since the binding cache 14 (see FIG. 30B) for the node 300 exists, the home agent 11 does not transfer the packet 71 to the link 210 but receives the same instead of the node 300.

\mathring{5} The home agent 11 generates the encapsulated packet 72 which is the packet 71 encapsulated with the CoA=“20.10” based on the binding information for the node 300, and then provides the packet 72 to the packet switch 21.

FIG. 33B shows an arrangement of the encapsulated packet 72, which is composed of an encapsulated header 72a and a payload 72b. The header 72a is composed of the CoA=“20.10” of the node 300 which is a destination address 72_1 and the address=“10.1” of the home agent 11 which is a source address 72_2. The packet 71 is inserted as it is into the payload 72b.

\mathring{6} The routing processor 23 retrieves the routing table 24 based on the destination address=“20.10” of the packet 72 to determine the interface 10_2 for the interface to be outputted (see 24b in FIG. 31).

\mathring{7} The packet switch 21 outputs the packet 72 to the interface 10_2, which transmits the packet 72 to the router 120.

As shown in FIGS. 29 and 32, in the prior art router 110 where the home agent 11 operates, the binding update process from the node 300 which has moved and the encapsulation of the packet 71 addressed to the node 300 are always performed at the link interface 10_1 having the home agent function.

For this reason, when numerous packets 71 are transmitted to the node 300 which has moved and there are numerous nodes to be supported by the home agent 11, the loads of the above-mentioned binding update process and the encapsulation process are increased at the home agent 11, so that there is a possibility of a packet being delayed due to process queue, a packet being discarded due to a buffer overflow, or the like.

Also, within the router 110, the routing process for determining the output interfaces and a distribution process to the output interfaces are performed per BU packet 81, the BA packet 82, the packet 71 addressed to the node 300 (hereinafter, occasionally referred to as node 300-addressed packet 71), and the node 300-addressed encapsulated packet 72, thereby wasting process capabilities of the routing processor 23 and the packet switch 21, decreasing a packet process throughput of the entire router 110, and causing the packet delay and the packet discard.

In case of the delay and the discard of the packet addressed to the node 300 which has moved, the quality of communication executed at the node 300 deteriorates. Especially, when the process time of the BU packet 81 transmitted to the home agent 11 while the node 300 is moving is long, the update of the CoA at the binding cache 14 is delayed. For this reason, before the update of the CoA, the home agent 11 transfers the encapsulated packet 71 transmitted to the node 300 to the old CoA where the node does not exist because it has already moved, so that there are possibilities of numerous packets being discarded, the communication quality being deteriorated, and the communication itself being disconnected.

### SUMMARY OF THE INVENTION

It is accordingly an object of the present invention to provide a mobile node supporting router, connected to a network in which a Mobile IPv4/v6 operates, which avoids a packet delay and a packet discard causing a communication quality deterioration of a node by shortening encapsulation process time of a packet addressed to the mobile node and a mobile IP message process associated with the mobile node.

In order to achieve the above-mentioned object, a mobile node supporting router according to the present invention comprises: a home link interface connected to a home link of a mobile node; and a foreign link interface connected to a foreign link of the node; the foreign link interface having an encapsulating cache for storing binding information of the node and a processor for encapsulating a packet addressed to the node with a care-of address included in the binding information (claim 1).

FIG. 1 shows an arrangement of a mobile node supporting router 100 according to the present invention. This router 100 is different from the prior art mobile node supporting router 110 shown in FIG. 28 in that e.g. the foreign link interface 10_3 connected to the foreign link 240 except the home link 210 of the movable node 300 (see FIG. 26; hereinafter occasionally referred to as mobile node 300) is provided with an encapsulating cache 12_3 and a processor 13_3.

Similarly, the foreign link interface 10_2 connected to the foreign link 250 is also provided with an encapsulating cache 12_2 (hereinafter, the caches 12_2 and 12_3 are occasionally represented by a reference numeral 12) and the processor 13.

Also, while the packet transfer route 30 through which the routing processor 23 transfers the packet based on the routing table 24 is the same, it is also different that there is a route through which the packet is immediately transferred (see thick dotted line in FIG. 1; this route is also referred to as a packet transfer route, which will be described later) mutually between the link interfaces 10 without retrieving the routing table 24.

It is to be noted that the in-device control route 31 which connects the interfaces 10_1-10_3 and the controller 22 in FIG. 1 will be occasionally omitted in the following Figures for convenience sake. Also, the binding cache 14 included in the home agent 11 will be also omitted in the following Figures for convenience sake.

The cache 12_3 stores, as shown in FIG. 2, e.g. home address=“10.10” of the mobile node 300 in association with the CoA=“20.10” as the binding information. The home address and the CoA are necessary information for encapsulating e.g. the mobile node 300-addressed packet (claim 2).

Hereinafter, the operation in case of the router 110 being replaced with the router 100 according to the present invention in the network shown in FIG. 26 will be described.

The processor 13 of the interface 10_3 receives e.g. the mobile node 300-addressed packet 71 transmitted from the mobile node 310 (see FIG. 27) through the router 130 and the foreign link 240. The processor 13 encapsulates the received packet 71 with the CoA based on the binding information to be transmitted.

Thus, the encapsulation process of the mobile node 300-addressed packet 71 is performed not through the home agent 11 of the interface 10_1, thereby enabling the encapsulating process time to be shortened.

FIG. 3 shows an operation principle (1) of the router 100 according to the present invention. The operation in which the router 100 transfers the mobile node 300-addressed packet 71 transmitted by the node 310 shown in FIG. 27 will be more specifically described.

\mathring{1} The packet 71 transmitted by the node 310 arrives at the router 100 through the router 130. The interface 10_3 in the router 100 receives the packet 71.

\mathring{2} At the link interface 10_3, the processor 13_3 retrieves the information of the cache 12_3 (see FIG. 2) based on the destination address (home address of the mobile node 300)=“10.10” of the received packet 71 (see FIG. 33A). In case the cache 12_3 has stored the binding information associating the home address of the mobile node 300 with the CoA, the processor 13_3 prepares the packet 72 (see FIG. 33B) which is the packet 71 encapsulated for the CoA.

\mathring{3} The processor 13_3 provides the packet 72 to the packet switch 21.

\mathring{4} The routing processor 23 retrieves the routing table 24 (see 24b in FIG. 31) based on the destination address (CoA of mobile node 300)=“20.10” of the packet 72 to determine the interface 10_2 for the interface to be outputted.

\mathring{5} The packet switch 21 outputs the packet 72 to the interface 10_2, which transmits the packet 72 to the router 120 through the link 250.

As shown in the above-mentioned operations \mathring{3}-\mathring{5}, the router 100 according to the present invention can transfer the encapsulated packet 72 to the output interface 10_2 based on the routing table 24 through the packet switch 21 and the packet transferring bus 30. Hereinafter, this transfer route is occasionally referred to as packet transfer route 30 (claim 5).

Also, in the present invention according to the above-mentioned invention, the binding information may include a lifetime of the binding information itself (claim 4). Thus, it becomes possible to automatically delete the binding information of the former foreign link, when the mobile node 300 moves from a foreign link where it is located to another foreign link.

Also, in the present invention, the above-mentioned binding information may further associate an output interface which outputs the encapsulated packet with the care-of address (claim 3), and based on this binding information, the processor may provide the encapsulated packet to the output interface (claim 6).

FIG. 4 shows an operation principle (2) of the router 100 according to the present invention. This router 100 is different from that shown in FIG. 3 in that the cache 12_3 stores not only the contents of the cache 12_3 shown in FIG. 2 but also the output interface 10_2 corresponding to the CoA=“20.10” of the mobile node 300 as shown in FIG. 5.

Also, the processor 13, different from that shown in FIG. 2, directly provides the encapsulated packet to the output interface 10_2 without retrieving the routing table 24.

Hereinafter, the operation procedure in which the router 100 transfers the mobile node-addressed packet will be more specifically described referring to FIG. 4.

\mathring{1} The packet 71 transmitted by the node 310 is transmitted to the router 100 through the router 130 and the link 240 (see FIG. 27). In the router 100, the interface 10_3 receives the packet 71.

\mathring{2} At the interface 10_3, the processor 13_3 retrieves the cache 12_3 to obtain the CoA=“20.10” of the node 300 corresponding to the destination address (home address of the node 300)=“10.10” of the received packet 71 (see FIG. 5). The processor 13_3 prepares the encapsulated packet 72 that is the packet 71 encapsulated for the CoA=“20.10”.

\mathring{3} Furthermore, the processor 13 detects the interface 10_2 corresponding to the CoA=“20.10” of the node 300 based on the cache 12_3, so that the packet 72 is provided to the interface 10_2.

\mathring{4} The interface 10_2 transmits the packet 72 to the router 120.

Thus, the packet 72 is directly provided to the output interface 10_2 without performing the retrieval process of the routing table 24, so that the load of the packet transfer route is lightened.

Also, in the present invention according to the above-mentioned invention, when receiving a binding demand packet from the node, the processor may store the binding information included in the binding demand packet in the encapsulating cache (claim 7).

Namely, FIG. 6 shows an operation principle (3) of the router 100 according to the present invention. In this router 100, e.g. the interface 10_2 connected to the foreign link 250 of the mobile node 300 has the encapsulating cache 12_2 and the processor 13_2 in the same way as the above-mentioned interface 10_3.

FIG. 7 shows contents stored in the cache 12_2, that are the same as the binding information of the mobile node 300 stored in the binding cache 14 (see FIG. 1) included in the home agent 11.

In FIG. 6, the processor 13_2 receives a binding demand packet (BU packet) 81 from the mobile node 300, and can update the contents of the encapsulating cache 12_2 by the binding information included in the binding demand packet 81.

Furthermore, in the present invention, the above-mentioned processor 13_2 may provide a binding reply packet for the binding demand packet 81 to the output interface through the packet transfer route 30 (claim 8).

Namely, in FIG. 6, the processor 13_2 can prepare the binding reply packet 82 in response to the binding demand packet 81, and can provide this packet 82 to the output interface 10_2 through the packet transfer route 30, i.e. through the packet switch 21.

Hereinafter, an example of the mobile IP message process in the router 100 in case the mobile node 300 registers the location will be specifically described referring to FIG. 6.

\mathring{1} The binding demand packet 81 (see FIG. 30A) transmitted by the mobile node 300 which has moved to the link 220 is transmitted to the router 100 through the router 120 and the link 250 (see FIG. 26), so that the interface 10_2 receives the packet 81 in the router 100.

\mathring{2} At the interface 10_2, the processor 13_2 analyzes the classification of the received packet 81 to detect that the packet 81 is a binding demand packet. The processor 13_2 retrieves whether or not the binding information for the home address=“10.10” of the mobile node 300 shown in the home address option 81c (see FIG. 30A) included in the packet 81 exists in the cache 12_2.

When the binding information of the mobile node 300 is stored in the cache 12_2, the processor 13_2 updates the binding information (see FIG. 7 or 30B) on the mobile node 300 in the cache 12_2 based on the contents of the packet 81, and generates the binding reply packet 82 (see FIG. 30C) as a reply packet to the packet 81.

\mathring{3} The processor 13_2 outputs the packet 82 to the packet switch 21.

\mathring{4} The routing processor 23 retrieves the routing table 24 (see FIG. 31) based on the destination address (CoA of the node 300)=“20.10” of the packet 82 to determine the interface 10_2 for the interface to be outputted.

\mathring{5} The packet switch 21 provides the packet 82 to the interface 10_2, which transmits the packet 82 to the router 120.

Thus, the processor 13_2 performs the mobile IP message process instead of the home agent 11, thereby enabling the message process time to be shortened.

Also, in the present invention according to the above-mentioned invention, the encapsulating cache may store an output interface for outputting the binding reply packet in association with a care-of address of the node within the binding information, and the processor may provide the binding reply packet to the output interface based on the binding information (claim 9).

FIG. 8 shows an operation principle (4) of the router 100 according to the present invention. This router 100 is different from that shown in FIG. 6 in that the cache 12_2 of the interface 10_2 stores not only the binding information shown in FIG. 7 but also the output interface 10_2 corresponding to the CoA=“20.10” of the node 300 as shown in FIG. 9.

Also, the router 100 of FIG. 8 is different from that of FIG. 6 in that the processor 13_2 provides the binding reply packet 82 for the binding demand packet 81 to the output interface 10_2 referring to the cache 12_2.

Hereinafter, the operation of the router 100 will be specifically described referring to FIG. 8.

\mathring{1} The binding demand packet 81 (see FIG. 30A) transmitted by the node 300 which has moved to the link 220 is transmitted to the router 100 through the router 120 and the link 250. In the router 100, the interface 10_2 receives the packet 81.

\mathring{2} At the interface 10_2, the processor 13_2 analyzes the classification of the received packet 81 to detect that the packet 81 is a binding demand packet. Then, the processor 13_2 retrieves whether or not the binding information about the home address=“10.10” of the node 300 shown in the home address option 81c included in the packet 81 exists in the cache 12_2.

When the cache 12_2 has stored the binding information of the home address=“10.10”, the processor 13_2 updates the cache 12_2 based on the contents of the packet 81, and generates the binding reply packet 82 as a reply to the packet 81 (see FIG. 30C).

\mathring{3} The processor 13_2 retrieves the interface 10_2 which is the output interface of the packet 82 referring to the cache 12_2, and provides the packet 82 to the interface 10_2 through the in-device control route 31. Namely, the packet 82 is provided to the packet transmission side of the same interface 10_2 from the packet receiving side of the interface 10_2.

\mathring{4} The interface 10_2 transmits the packet 82 to the router 120.

Thus, the packet 82 is transmitted to the interface 10_2 not through the packet switch 21, thereby enabling the speed of the reply packet return to be enhanced.

In the above-mentioned operation principles (1) and (2) of the present invention respectively described referring to FIGS. 3 and 4, the procedure of the transfer process of the mobile node-addressed packet has been described, while in the operation principles (3) and (4) of the present invention respectively described referring to FIGS. 6 and 8, the exchange process of the mobile IP messages and the acquisition of the binding information of the encapsulating cache have been described.

Hereinafter, in the operation principles (5)-(12) of the present invention respectively described referring to FIGS. 10, 12, 14-19, the procedure in which the foreign link interface acquires the binding information (occasionally, referred to as cache information) shown in FIGS. 2, 5, 7, and 9 from the home agent in case the packet addressed to the mobile node or the packet from the mobile node is received and the encapsulating cache does not store the binding information of the mobile node will be described.

It is to be noted that the basic arrangement of the mobile node supporting router 100 according to the present invention in the operation principles (5)-(12) of the present invention is the same as that of the mobile node supporting router 100 shown in FIG. 1.

Also, in the mobile node supporting router 100 of the present invention according to the above-mentioned invention, when the encapsulating cache does not store the binding information of the node upon receiving a packet associated with the node, the processor may acquire the binding information from a home agent (claim 10).

It is to be noted that the packet addressed to the node and the binding demand packet from the node are included in the above-mentioned packet associated with the node (claims 11 and 12).

Namely, in FIG. 1, when a packet associated with the node 300, e.g. a node 300-addressed packet is received and the cache 12_3 does not store the binding information of the node 300, the processor 13_3 of the foreign link interface 10_3 for the mobile node 300 can not encapsulate the received packet.

In such a case, the processor 13_3 can acquire the binding information on the node 300 from the home agent and write the same in the cache 12_3.

Thus, it becomes possible for the cache 12_3 to acquire and store the binding information on the node 300, and for the processor to encapsulate the packet when the processor receives the packet associated with the node.

Also, in the present invention according to the above-mentioned invention, the processor may notify the home agent, by a request message, that the processor does not store the binding information (claim 13).

FIG. 10 shows an operation principle (5) of the mobile node supporting router 100 according to the present invention. In this principle (5), a message of requesting the CoA of the mobile node 300 is transmitted from the link interface 10_3 to the home agent 11 by the same transfer method as a usual packet.

It is supposed that the cache 12_3 does not store any binding information.

\mathring{1} The packet 71 (see FIG. 33A) transmitted by the node 310 arrives at the router 100 through the router 130. At the router 100, the interface 10_3 receives the packet 71.

\mathring{2} At the interface 10_3, the processor 13_3 retrieves the information of the cache 12_3 based on the destination address (home address=“10.10” of the node 300) of the received packet 71. In case the cache 12_3 does not store the binding information (CoA) of the destination address, the processor 13_3 generates a request message 73 for requesting the CoA of the home agent 11.

FIG. 11A shows an arrangement of a request message 73. This request message 73 is composed of an IP header 73a and a new option 73b. The IP header 73a is composed of a destination address 73_1 of the packet 71=the home address “10.10” of the node 300, and a source address 73_2 of the packet 71=the address “30.11” of the node 310. In the new option 73b, “indication 73_3 of request message” i.e. “request contents being “CoA”” is indicated.

\mathring{3} The processor 13_3 provides the received packet 71 and the generated request message 73 to the packet switch 21.

\mathring{4}, \mathring{4}′ Hereafter, the packet 71 and the request message 73 are transferred to the interface 10_1 through the packet transfer route 30 shown in FIG. 32.

Namely, the routing processor 23 retrieves the routing table 24 (see FIG. 31) based on the destination address (home address=10.10 of the node 300) of the packet 71 and the request message 73 to determine the interface 10_1 for the interface to be outputted in the above-mentioned \mathring{4}. Packet switch 21 provides the packet 71 and the request message 73 to the interface 10_1 in the above-mentioned \mathring{4}′.

By the request message among them, the processor 13_3 at the interface 10_3 can notify the home agent 11 that the binding information of the node 300 is not stored in the cache 12_3.

Hereinafter, the procedure in which the home agent 11 notifies the binding information to the processor 13_3 will be described

Namely, in the present invention according to the above-mentioned invention, when receiving a notification that the encapsulating cache 12_3 does not store the binding information, the home agent 11 may notify necessary information to the processor 13_3 from the binding cache held by the home agent itself (claim 17).

\mathring{5} Home agent 11 checks whether or not the destination address of the packet 71 and the binding cache corresponding thereto exist. Since the binding cache (see FIG. 30B) for the node 300 exists, the home agent 11 does not transfer the packet 71 to the link 210 but receives the same instead of the node 300, and encapsulates the packet 71 with the CoA=“20.10” based on the binding cache of the node 300.

Also, the home agent 11 analyzes the classification of the received request message (packet) 73 to detect that the inputted packet 73 is a request message. Based on this request message, the home agent 11 generates a reply message 74 for notifying the CoA=“20.10” of the node 300 to the interface 10_3 from the binding cache of the node 300.

FIG. 11B shows an arrangement of a reply message 74. This reply message 74 is composed of an IP header 74a and a new option 74b. The IP header 74a is composed of a destination address (source address of the packet 71) 74_1 and a source address (destination address of the packet 71) 74_2. The new option 74b is composed of “indication 74_3 of reply message” and “CoA 74_4 of the node 300”.

It is to be noted that since the messages shown in FIGS. 11A and 11B are exchanged independently within the router 100 of the present invention, a specific new option not defined by the IP standard is used.

The home agent 11 stores the source address (“30.11” in this case) of the request message 73. This is for transmitting the information to the foreign link interface 10_3 in case the home agent 11 receives the binding demand packet from e.g. the node 300 and the binding information (CoA) is changed (claim 21).

It is to be noted that the home agent 11 retrieves the routing table 24 (see FIG. 31) based on the source address “30.11”, thereby specifying the foreign link interface 10_3.

\mathring{6} The home agent 11 provides the packet 72 and the reply message 74 to the packet switch 21.

\mathring{7}, \mathring{7}′, \mathring{7}″ The packet 72 and the reply message 74 are respectively transferred to the interfaces 10_2 and 10_3 through the packet transfer route 30.

Namely, the routing processor 23 retrieves the routing table 24 (see FIG. 31) based on the destination address of the packet 72=the CoA “20.10” of the node 300 to determine the interface 10_2 for the interface to be outputted in the above-mentioned \mathring{7}.

Also, the routing processor 23 retrieves the routing table 24 based on the destination address of the reply packet 74=source address “30.11” of the packet 71 to determine the interface 10_3 for the interface to be outputted.

\mathring{7}′ The packet switch 21 provides the packet 72 to the interface 10_2, which transmits the packet 72 to the router 120.

\mathring{7}″ The packet switch 21 provides the reply message 74 to the interface 10_3.

\mathring{8} At the interface 10_3, the processor 13_3 analyzes the classification of the inputted reply message (packet) 74 to detect that the packet 74 is a reply message. The processor 13_3 stores the CoA=“20.10” of the node 300 notified from the home agent 11 in the cache 12_3 based on the contents of the reply message 74.

Thus, the home agent 11 may notify the binding information by the reply message 74 through the packet transfer route 30 (claim 18).

By the above-mentioned information acquisition process of the cache 12_3, the cache contents shown in FIG. 2 are generated at the interface 10_3. Hereafter, it becomes possible for the processor 13_3 to transfer the node 300-addressed packet 71, as shown in FIG. 3, while the cache contents are stored.

FIG. 12 shows an operation principle (6) of the router 100 according to the present invention. This principle (6) is different from the principle (5) shown in FIG. 10 in that when receiving the binding demand packet 81 from the mobile node 300 instead of the node 300-addressed packet 71, the foreign link interface transmits the request message of requesting the binding information of the node to the home agent 11 through the packet transfer route 30 in the same operation as that in FIG. 10.

It is supposed that the cache 12_2 does not store any binding information.

Hereinafter, an example of the cache information acquisition based on the operation principle (6) will be described in more detail.

\mathring{1} The binding demand packet 81 (see FIG. 30A) transmitted by the node 300 is transmitted to the router 100 through the router 120, so that the interface 10_2 receives the packet 81 in the router 100.

\mathring{2} At the interface 10_2, the processor 13_2 analyzes the classification of the received packet 81 to detect that the packet 81 is the binding demand packet. Then, the processor 13_2 retrieves whether or not the binding information of the home address=“10.10” of the node 300 shown in the home address option 81c included in the packet 81 exists in the cache 12_2.

In case no binding information of the node 300 is stored in the cache 12_2, the processor 13_2 generates a request message 83 for requesting the binding information of the node 300 from the home agent 11.

FIG. 13A shows an arrangement of a request message 83, which is composed of an IP header 83a, a new option 83b, and a home address option 83c. The IP header 83a is composed of a destination address 83_1=“10.1” of the binding demand packet 81, and a source address 83_2=“20.10”. The new option 83b is composed of “indication 83_3 of request message”, and the home address option 83c is composed of “home address 83_4 of the mobile node 300”=“10.10”.

Thus, in the present invention, even if receiving the binding demand packet 81 from the mobile node, the processor can request the binding information of the home agent 11 by the request message 83 (claims 12 and 13).

\mathring{3} The processor 13_3 provides the received binding demand packet 81 and the generated request message 83 to the packet switch 21.

\mathring{4}, \mathring{4}′ Hereafter, the binding demand packet 81 and the request message 83 are transmitted to the interface 10_1 through the packet transfer route 30 in the same way as the principle (5) of the invention shown in FIG. 10. Namely, since the destination addresses of the binding demand packet 81 and the request message (packet) 83 are the same address=“10.1” of the home agent 11, both of the packets 81 and 83 are inputted to the interface 10_1 through the packet transfer route 30.

\mathring{5} At the interface 10_1, the home agent 11 checks the destination address of the packet 81 and receives the packet 81 since the destination address is its address of the home agent 11. The home agent 11 analyzes the contents of the packet 81 to generate the binding information (see FIG. 30B) of the node 300 at the binding cache 14. It is to be noted that in the presence of the binding information of the node 300 at the cache 14, the binding information is updated.

The home agent 11 generates the binding reply packet 82 as a reply packet for the binding demand packet 81.

Also, the home agent 11 similarly analyzes the classification of the received request message (packet) 83 to detect that the packet 83 is a request message. The home agent 11 generates a reply message 84 for notifying the binding information of the node 300 to the interface 10_2 based on the contents of the request message 83.

FIG. 13B shows an arrangement of a reply message 84, which is composed of an IP header 84a and a new option 84b. The IP header 84a is composed of the destination address 84_1=source address “20.10” of the packet 71, and the source address 84_2=destination address=“10.1” of the packet 71. The new option 84b is composed of “indication 84_3 of reply message” and binding information 84_4.

It is to be noted that since the messages shown in FIGS. 13A and 13B are exchanged independently within the router, specific new options 83b and 84b not defined by the IP standard are used.

Also, when the binding information of the node 300 is changed later, the home agent 11 preliminarily stores the source address (“20.10” in this case) of the request message 83 in order to notify the change (claim 21).

\mathring{6} The interface 10_1 provides the binding reply packet 82 and the reply message 84 to the packet switch 21.

\mathring{7}, \mathring{7}′, \mathring{7}″ The binding reply packet 82 and the reply message 84 are transmitted to the interface 10_2 through the packet transfer route 30. The interface 10_2 transmits the packet 82 to the router 120.

\mathring{8} At the interface 10_2, the processor 13_2 detects the indication 84_3 included in the inputted reply message (packet) 84 to recognize that the packet 84 is a reply message. The processor 13_2 stores the binding information 84_4 of the node 300 notified from the home agent 11 based on the contents of the reply message.

By the above-mentioned process, the binding information on the mobile node 300 as shown in FIG. 7 is generated in the cache 12_2. Hereafter, while this binding information is stored, it becomes possible for the processor 13_2 to perform a process of the operation principle (3) shown in FIG. 6 to the binding demand packet 81 periodically transmitted to the home agent 11 from the node 300.

FIG. 14 shows an operation principle (7) of the router 100 according to the present invention, which shows another example of the cache information acquisition method. In this principle (7), another example of cash information acquisition method is indicated. The processor acquires the binding information from the home agent 11 not through the packet transfer route 30 by a usual routing but through the in-device control route 31 (claims 10 and 15).

It is supposed that the cache 12_3 does not store any binding information.

\mathring{1} The packet 71 transmitted by the node 310 is transmitted to the router 100 through the router 130. In the router 100, the interface 10_3 receives the packet 71.

\mathring{2} At the interface 10_3, the processor 13_3 retrieves the binding information of the cache 12_3 based on the destination address of the received packet 71=the home address “10.10” of the node 300.

\mathring{3} (When the processor 13_3 does not store the binding information (CoA) on the destination address of the packet 71, the received packet 71 is inputted to the packet switch 21.

\mathring{4}, \mathring{4}′ The packet 71 is inputted to the interface 10_1 through the packet transfer route 30.

\mathring{5} At the interface 10_1, the home agent 11 checks the destination address of the packet 71 and whether or not the binding cache for the destination address exists. Since there is a binding cache (see FIG. 30B) for the node 300, the home agent 11 does not transfer the packet 71 to the link 210 but generates the packet 72 that is the packet 71 encapsulated with the CoA based on the binding information for the node 300.

\mathring{6} The home agent 11 provides the packet 72 to the packet switch 21.

\mathring{7}, \mathring{7}′ The packet 72 is inputted to the interface 10_2 through the packet transfer route 30. The interface 10_2 transmits the packet 72 to the router 120.

\mathring{8} Since the cache does not store the binding information (CoA) of the destination address of the packet 71 in the above-mentioned \mathring{3} at the interface 10_3, the processor 13_3 attempts to acquire the CoA by using the in-device control route 31.

The processor 13_3 firstly recognizes by referring to the routing table 24 (see FIG. 31) through the control bus 31 that the output interface for the destination address=“10.10” of the packet 71 (see FIG. 33) is the interface 10_1 (see 24a of FIG. 31).

Thus, in the present invention, the processor may acquire necessary information (output interface information in this case) from the routing table through e.g. the control bus 31 (claim 16).

Then, the processor 13_3 confirms whether or not the binding information of the destination address=“10.10” of the packet 71 is held in the binding cache 14 for the home agent 11 of the interface 10_1. If it is the case, the processor 13_3 acquires the CoA=“20.10” from the binding information.

Furthermore, the processor 13_3 acquires the information of the output interface (interface 10_2 in this case) for the CoA=“20.10” (see 24b in FIG. 31) referring to the routing table 24 again based on the acquired CoA, and then stores the same in the cache 12_3.

It is to be noted that when the CoA of the node 300 is changed later, the home agent 11 stores the interface 10_3 that is an interface having acquired the CoA in order to notify the change (claim 21).

By the above-mentioned process, the binding information shown in FIG. 5 is generated in the cache 12_3 of the interface 10_3. Hereafter, it becomes possible for the processor 13_3 to process the node 300-addressed packet 71 in the same way as the principle (2) shown in FIG. 4 while the binding information is stored.

FIG. 15 shows an operation principle (8) of the router 100 according to the present invention, which shows another example of the cache information acquisition method. In this example, the processor, different from the principle (7) shown in FIG. 14, acquires the binding information in the cache by using the in-device control route 31 in the same way as in FIG. 14, upon the reception of the binding demand packet from the mobile node instead of the mobile node-addressed packet as a trigger (claims 10, 12 and 15).

It is supposed that the cache 12_2 does not store any binding information.

\mathring{1} The binding demand packet 81 (see FIG. 30A) transmitted by the node 300 is transmitted to the router 100 through the router 120. In the router 100, the interface 10_2 receives the packet 81.

\mathring{2} At the interface 10_2, the processor 13_2 analyzes the classification of the packet 81, detects that the packet 81 is a binding demand packet, and then retrieves whether or not the binding information for the home address=“10.10” of the node 300 shown in the home address option 81c included in the packet 81 exists in the cache 12_2.

\mathring{3} In case the cache 12_2 does not store the binding information on the node 300, the processor 13_2 provides the received binding demand packet 81 to the packet switch 21.

\mathring{4}, \mathring{4}′ The packet 81 is transferred to the interface 10_1 through the packet transfer route 30.

\mathring{5} At the interface 10_1, the home agent 11 checks the destination address of the packet 81, and receives the packet 81 since the destination address is its address of the home agent. The home agent 11 analyzes the contents of the packet 81 to generate the binding cache (see FIG. 30B) for the node 300. (In case the binding cache for the node 300 already exists, the information of the binding cache is updated.) The home agent 11 generates the binding reply packet 82 as a reply to the binding demand packet 81.

\mathring{6} The home agent 11 provides the packet 82 to the packet switch 21.

\mathring{7}, \mathring{7}′ The packet 82 is transferred to the interface 10_2 through the packet transfer route 30. The interface 10 2 transmits the packet 82 to the router 120.

\mathring{8} Since the cache 12_2 has not stored the binding information (CoA) of the node 300 that is the source of the binding demand packet 82 in the above-mentioned \mathring{3} at the interface 10_2, the processor 13_2 attempts to acquire the binding information by using the in-device control route 31.

Namely, the processor 13_2 recognizes that the output interface for the address “10.1” of the home agent 11 that is the destination of the packet 81 is the interface 10_1 (see 24a in FIG. 31) referring to the routing table 24 (see FIG. 31).

Then, the processor 13_2 confirms that the binding cache 14 holds the binding information of the node 300 for the home agent 11 of the interface 10_1. When it is held, the processor 13_2 acquires the binding information of the node 300. Furthermore, the processor 13_2 acquires the information of the interface 10_2 including the processor 13_2 itself which has acquired the packet 81 from the node 300 to be stored in the cache 12_2.

It is to be noted that when the binding cache of the node 300 is changed later, the home agent 11 preliminarily stores the interface 10_2 which has acquired the binding information in order to notify the change to the interface 10_2 (claim 21).

By the above-mentioned process, the binding information on the mobile node 300 as shown in FIG. 9 is generated in the cache 12_2. Hereafter, while the binding information is stored, it becomes possible for the processor 13_2 to process the binding demand packet 81, as shown in FIG. 8, periodically transmitted to the home agent 11 from the node 300.

FIG. 16 shows an operation principle (9) of the router 100 according to the present invention. This principle (9) shows another example of the cache information acquisition method. In case the cache 12_3 does not store the binding information on the mobile node 300, the processor 13_3 of the foreign link interface 10_3 transmits the mobile node 300-addressed packet 71 received, to which the identifier of the link interface 10_3, to which the processor itself belongs, is assigned, to the home agent 11 through the packet transfer route 30.

When the home agent 11 receives the packet 71 to which the identifier is assigned, the processor 13_3 of the link interface 10_3 recognizes that the binding information on the node 300 is requested (claims 10, 11, and 14).

It is supposed that the cache 12_3 does not store any binding information on the node 300.

\mathring{1} The packet 71 (see FIG. 33A) transmitted by the node 310 is transmitted to the router 100 through the router 130. In the router 100, the interface 10_3 receives the packet 71.

\mathring{2} At the interface 10_3, the processor 13_3 retrieves the binding information of the cache 12_3 based on the destination address of the received packet 71=the home address “10.10” of the node 300. In case the cache 12_3 does not store the binding information (CoA) of the destination address, the processor 13_3 can not encapsulate the packet 71. Therefore, only the identifier 75=“#3” of the interface 10_3 is assigned to the packet 71.

\mathring{3} The processor 13_3 provides the packet 71 to the packet switch 21.

\mathring{4}, \mathring{4}′ The packet 71 is transmitted to the interface 10_1 through the packet transfer route 30.

\mathring{5} At the interface 10_1, the home agent 11 checks whether or not the binding information for the home address=“10.10” of the node 300 that is the destination address of the packet 71 exists in the binding cache 14.

Since the binding information (see FIG. 30B) of the node 300 exists, the home agent 11 receives the packet 71 instead of the node 300 without transferring the packet 71 to the link 210, assigns the identifier=“#1” of the interface 10_1, to which the home agent itself belongs, to the packet 71 based on the binding information on the node 300, and then generates the packet 72 encapsulated with the CoA (claim 20).

The reason why the home agent 11 assigns the identifier=“#1” of the interface 10_1, to which the home agent itself belongs, to the packet 71 is that the operations of the home agent 11 and the processor 13_3 are generally performed in the same function block. Therefore, the identifier assignment performed at the processor 13_3 is also performed at the home agent 11.

Instead of performing such an identifier assignment, the home agent 11 may encapsulate the packet 71 with the CoA after deleting the identifier 75=“#3” included in the received packet 71. In this case, it is not necessary for the processor 13_2 to delete the identifier 76=“#1” from the packet 72.

Furthermore, the home agent 11 generates the reply message 74 for notifying the binding information (CoA) of the node 300 having the destination address of the received packet 71 to the interface 10_3.

It is to be noted that when the CoA of the node 300 is changed later, the interface 10_1 preliminarily stores the identifier of the source interface (interface 10_3 in this case) of the packet 71 in order to notify the change (claim 21).

\mathring{6} The home agent 11 provides the packet 72 to the packet switch 21.

\mathring{7}, \mathring{7}′ The packet 72 is transmitted to the interface 10_2 through the packet transfer route. At the interface 10_2, the processor 13_2 deletes the identifier 76=“#1” of the source interface (interface 10_1 in this case) assigned to the packet 72 to be transmitted to the router 120.

\mathring{8} The home agent 11 provides the reply message (packet) 74 generated at \mathring{5} to the interface 10_3 through the packet transfer route 30 based on the identifier assigned to the packet 71.

\mathring{9} At the interface 10_3, the processor 13_3 analyzes the classification of the inputted packet to detect that the inputted packet 74 is a reply message. The processor 13_3 stores the binding information (CoA) of the node 300 notified from the home agent 11 in the cache 12_3 based on the contents of the reply message.

By the above-mentioned process, the binding information as shown in FIG. 2 is generated in the cache 12_3. Hereafter, while the binding information is stored, it becomes possible for the processor 13_3 to perform the transfer process of the principle (1) shown in FIG. 3 to the node 300-addressed packet 71.

FIG. 17 shows an operation principle (10) of the router 100 according to the present invention, which shows another example of the cache information acquisition method. This example is different from the principle (9) shown in FIG. 16 in that the foreign link interface requests the binding information on the node 300 of the home agent 11 by transmitting the packet 81, to which the identifier of the link interface is assigned, to the home agent 11 through the packet transfer route 30, upon the reception of the binding demand packet 81 from the mobile node 300 instead of the mobile node 300-addressed packet 71 as a trigger (claims 10, 12, and 14).

It is supposed that the cache 13_2 does not store any binding information of the node 300.

\mathring{1} The binding demand packet 81 (see FIG. 30A) transmitted by the node 300 is transmitted to the router 100 through the router 120. In the router 100, the interface 10_2 receives the packet 81.

\mathring{2} At the interface 10_2, the processor 13_2 analyzes the classification of the received packet 81 to detect that the packet 81 is a binding demand packet. Then, the processor 13_2 retrieves whether or not the binding information on the home address=“10.10” of the node 300 shown in the home address option 81c included in the packet 81 exists in the cache 12_2.

If the cache 12_2 does not store any binding information (CoA) on the node 300, the processor 13_2 only assigns the identifier 85=“#2” of the interface 10_2 to the packet 81 without processing the binding demand packet 81 by itself.

\mathring{3} The processor 13_2 provides the packet 81 to the packet switch 21.

\mathring{4}, \mathring{4}′ The packet 81 is transmitted to the interface 10_1 through the packet transfer route 30.

\mathring{5} At the interface 10_1, the home agent 11 checks the destination address of the packet 81, and receives the packet 81 since the destination is the home agent 11 itself. The home agent 11 analyzes the contents of the packet 81, and generates the binding information (see FIG. 30B) on the node 300 at the binding cache 14. It is to be noted that in case the binding information on the node 300 has already existed, the home agent 11 updates the binding information on the node 300.

The home agent 11 generates the binding reply packet 82 to which the identifier=“#1” of the interface 10_1, to which the home agent itself belongs, is assigned, as a reply to the binding demand packet 81, and generates the reply message 84 to which the identifier=85 “#1” for notifying the binding information of the node 300 to the interface 10_3 is assigned (claim 20).

It is to be noted that when the binding cache of the node 300 is changed later, the home agent 11 preliminarily stores the identifier of the source interface (interface 10_2 in this case) of the binding demand packet in order to notify the change (claim 21).

\mathring{6} The home agent 11 provides the generated packet 82 to the packet switch 21.

\mathring{7}, \mathring{7}′ The packet 82 is transmitted to the interface 10_2 through the packet transfer route 30. At the interface 10_2, the processor 13_2 transmits the packet 82 to the router 120 after deleting the identifier=“#1” assigned to the packet 82.

\mathring{8} The home agent 11 provides the reply message (packet) 84 generated at \mathring{5} to the interface 10_2 through the packet transfer route based on the identifier 85=“#2” assigned to the packet 81.

\mathring{9} At the interface 10_2, the processor 13_2 analyzes the classification of packet 84 to detect that the packet is a reply message. The processor 13_2 stores the binding information (CoA) of the node 300 notified from the home agent 11 in the cache 12_2 based on the contents of the reply message 84.

By the above-mentioned process, the binding information as shown in FIG. 7 is stored in the cache 12_2. Hereafter, during the binding information being stored, it becomes possible to process the binding demand packet 81 addressed to the node 300 as shown in FIG. 6.

FIG. 18 shows an operation principle (11) of the router 100 according to the present invention, which shows another example of the cache information acquisition method. In case the cache 12_3 does not store the binding information on the node 300, in the same way as the principle (9) shown in FIG. 16, the processor 13_3 transmits the packet 71 to which the identifier=“#3” of the interface 10_3, to which the processor itself belongs, is assigned to the home agent 11 through the packet transfer route 30 (claims 10, 11, and 14).

This example is different from the principle (9) in that the processor 13_3 requests the binding information on the node 300 of the home agent 11 through the in-device control route (claim 15).

It is supposed that the cache 12_3 does not store any binding information on the node 300.

\mathring{1}-\mathring{3}, \mathring{4}, and \mathring{4}′ are the same as \mathring{1}-\mathring{3}, \mathring{4}, and \mathring{4}′ in the principle (9) shown in FIG. 16.

\mathring{5} The home agent 11 checks whether or not the binding information corresponding to the destination address of the packet 71=the home address “10.10” of the mobile node 300 exists in the binding cache 14. Since the binding information on the node 300 exists, the home agent 11 does not transfer the packet 71 to the link 210 but receives the same instead of the node 300, and generates the packet 72 that is the packet 71 encapsulated with the CoA based on the binding information on the node 300.

It is to be noted that when the CoA of the node 300 is changed later, the home agent 11 preliminarily stores the identifier of the source interface (interface 10_3 in this case) of the packet 71 in order to notify the change (claim 21).

\mathring{6}, \mathring{7}, \mathring{7}′ are the same as \mathring{6}, \mathring{7}, \mathring{7}′ in the description of the principle (9) shown in FIG. 16.

\mathring{8} The home agent 11 notifies the binding information (CoA) of the node 300 to the interface 10_3 through the in-device control route based on the identifier=“#3” of the interface 10_3 assigned to the packet 71 (claim 19).

Furthermore, the home agent 11 notifies the information of the output interface (foreign interface 10_2) corresponding to the CoA=“20.10” of the node 300 to the interface 10_3 e.g. through the controlling bus 31, referring to the routing table 24 (see FIG. 31) (claim 16).

\mathring{9} At the interface 10_3, the processor 13_3 stores the binding information of the node 300 and the output interface 10_2 in the cache 12_3 based on the contents notified from the home agent 11.

By the above-mentioned process, the binding information shown in FIG. 5 is generated in the cache 12_3. Hereafter, during the binding information being stored, it becomes possible for the processor 13_3 to transfer the node 300-addressed packet 71 as shown in FIG. 4.

FIG. 19 shows an operation principle (12) of the router 100 according to the present invention, which shows another example of the cache information acquisition method. In case the cache 12_3 does not store the binding information on the mobile node 300 in this example, in the same way as the principle (10) shown in FIG. 17, the foreign link interface 10_2 requests the binding information on the node 300 of the home agent 11 by transmitting the packet 81, to which the identifier=“#2” of the link interface 10_2 is assigned, to the home agent 11 through the packet transfer route 30 upon a reception of the binding demand packet 81 as a trigger (claims 10, 12, and 14).

Also, the home agent 11 notifies the binding information on the node 300 to the source interface 10_2 through the in-device control route 31 instead of the packet transfer route 30 different from the principle (10) (claim 19).

It is supposed that the cache 12_2 does not store any binding information of the mobile node 300.

\mathring{1}-\mathring{3}, \mathring{4}, \mathring{4}′ are the same as \mathring{1}-\mathring{3}, \mathring{4}, \mathring{4}′ in the description of the principle (10) shown in FIG. 17.

\mathring{5} The home agent 11 checks the destination address of the packet 81, receives the packet 81 since the destination address is the home agent 11 itself, analyzes the contents of the packet 81, and generates the binding information on the node 300 in the binding cache 14 (when the binding cache 14 on the node 300 has already existed, the binding information on the node 300 is updated).

The home agent 11 generates the binding reply packet 82 as a reply to the binding demand packet 81.

When the binding cache of the node 300 is changed later, the home agent 11 preliminarily stores the identifier=“#2” of the source interface (interface 10_2 in this case) of the binding demand packet 81 in order to notify the change (claim 21).

\mathring{6}, \mathring{7}, \mathring{7}′ are the same as \mathring{6}, \mathring{7}, \mathring{7}′ in the description of the principle (10) shown in FIG. 17.

\mathring{8} The home agent 11 notifies the binding information of the mobile node 300 to the interface 10_2 through the control route 31 based on the identifier 87=“#2” assigned to the binding demand packet 81.

\mathring{9} At the interface 10_2, the processor 13_3 stores the binding information of the node 300 included in the packet 84 notified from the interface 10_1 in the cache 12_2. Furthermore, the processor 13_3 stores the information of the interface 10_2, to which the processor itself belongs, as an output interface corresponding to the CoA of the node 300 in the cache 12_2 together with the binding information.

By the above-mentioned process, the binding information as shown in FIG. 9 is generated in the cache 12_2. Hereafter, while the binding information is stored, it becomes possible for the processor 13_2 to process the binding demand packet 81 addressed to the node 300 as shown in FIG. 8.

Furthermore, the mobile node supporting router according to the present invention comprises: a home link interface connected to a home link of a mobile node; and a foreign link interface connected to a foreign link of the node; the foreign link interface including a processor for exchanging mobile IP messages instead of a home agent of the node and a cache for storing binding information of the node included in the mobile IP message (claim 22).

Namely, the arrangement of the router according to the present invention is the same as that shown in FIG. 1 except that the processor 13 and the cache 12 of the foreign link interface 10 shown in FIG. 1 serve the same function as the home agent 11 and the binding cache 14 included therein.

Namely, the processor 13 can exchange the mobile IP messages with the mobile node instead of the home agent, and the cache 12 can store the binding information of the mobile node included in the messages.

It is to be noted that as the above-mentioned mobile IP messages, e.g. the binding demand packet received from the node and the binding reply packet for the request packet can be exchanged (claim 23).

Also, the processor can transfer the binding reply packet (BA packet), as respectively shown in FIG. 8 or 9, through either the packet transfer route or the in-device control route.

Thus, the home agent does not have to exchange the mobile IP messages and can increase the speed of the message exchange.

Also, in the present invention according to the above-mentioned invention, when receiving information necessary for updating binding information which a binding cache of the home agent stores by the mobile IP message, the processor may transmit the necessary information to the home agent (claim 24).

Namely, when the processor of the foreign link interface exchanges the mobile IP messages of the mobile node instead of the home agent, it becomes impossible to update the binding information stored in the binding cache of the home agent. Therefore, the processor transmits the information required by the home agent, e.g. only the binding demand packet, in which the binding information is changed, to the home agent.

It becomes possible for the home agent which has received the binding demand packet to update the binding information of the binding cache. On the other hand, since the processor has already returned the binding reply packet, the home agent does not have to return the binding reply packet.

It is possible for the processor to transmit the information (binding demand packet) necessary for the home agent through either the packet transfer route or the in-device control route.

Thus, it becomes possible for the home agent to receive only the necessary information and it becomes unnecessary to return the reply message, thereby lightening the message transmission load on the packet transfer route or the in-device control route within the router.

While in the above, the case where the home agent is included in the home link interface connected to the home link has been described, in the mobile node supporting router according to the present invention, the home agent may be at least either on the home link or included in the home link interface (claim 25).

Namely, the home agent 11 may not be included in the home link interface of the router 100 according to the present invention but exist on the home link 210, e.g as a server.

In this case, in the above-mentioned description, the packet or the like transmitted to the home agent is further transmitted to the server (home agent) through the home link interface 10_1 and the home link 210, so that the server transmits the reply to the foreign link interface 10 through the home link 210 and the home link interface 10_1.

### BRIEF DESCRIPTION OF THE DRAWINGS

FIG. 1 is a block diagram showing an embodiment of a mobile node supporting router according to the present invention;

FIG. 2 is a diagram showing a content example (1) of an encapsulating cache in a mobile node supporting router according to the present invention;

FIG. 3 is a diagram showing an operation principle (1): an operation example of a packet transfer of a mobile node supporting router according to the present invention;

FIG. 4 is a diagram showing an operation principle (2): an operation example of a packet transfer of a mobile node supporting router according to the present invention;

FIG. 5 is a diagram showing a contents example (2) of an encapsulating cache in a mobile node supporting router according to the present invention;

FIG. 6 is a diagram showing an operation principle (3): a procedure example of mobile IP message exchange and information acquisition of a cache in a mobile node supporting router according to the present invention;

FIG. 7 is a diagram showing a content example (3) of an encapsulating cache in a mobile node supporting router according to the present invention;

FIG. 8 is a diagram showing an operation principle (4): a procedure example of mobile IP message exchange and information acquisition of a cache in a mobile node supporting router according to the present invention;

FIG. 9 is a diagram showing a content example (4) of an encapsulating cache in a mobile node supporting router according to the present invention;

FIG. 10 is a diagram showing an operation principle (5): a procedure example of an information acquisition of an encapsulating cache in a mobile node supporting router according to the present invention;

FIGS. 11A and 11B are diagrams showing an arrangement (1) of messages exchanged between link interfaces in a mobile node supporting router according to the present invention;

FIG. 12 is a diagram showing an operation principle (6): a procedure example of information acquisition of an encapsulating cache in a mobile node supporting router according to the present invention;

FIGS. 13A and 13B are diagrams showing an arrangement (2) of messages exchanged between link interfaces in a mobile node supporting router according to the present invention;

FIG. 14 is a diagram showing an operation principle (7): a procedure example of information acquisition of an encapsulating cache in a mobile node supporting router according to the present invention;

FIG. 15 is a diagram showing an operation principle (8): a procedure example of information acquisition of an encapsulating cache in a mobile node supporting router according to the present invention;

FIG. 16 is a diagram showing an operation principle (9): a procedure example of information acquisition of an encapsulating cache in a mobile node supporting router according to the present invention;

FIG. 17 is a diagram showing an operation principle (10): a procedure example of information acquisition of an encapsulating cache in a mobile node supporting router according to the present invention;

FIG. 18 is a diagram showing an operation principle (11): a procedure example of information acquisition of an encapsulating cache in a mobile node supporting router according to the present invention;

FIG. 19 is a diagram showing an operation principle (12): a procedure example of information acquisition of an encapsulating cache in a mobile node supporting router according to the present invention;

FIG. 20 is a block diagram showing an embodiment: an arrangement of a mobile node supporting router according to the present invention;

FIG. 21 is a flow chart showing a procedure example (1) of a packet reception process in a foreign link interface of a mobile node supporting router according to the present invention;

FIG. 22 is a flow chart showing a procedure example (1) of a packet reception process in a home link interface of a mobile node supporting router according to the present invention;

FIG. 23 is a flow chart showing a procedure example (2) of a packet reception process in a foreign link interface of a mobile node supporting router according to the present invention;

FIG. 24 is a flow chart showing a procedure example (2) of a packet reception process in a home link interface of a mobile node supporting router according to the present invention;

FIG. 25 is a flow chart showing a procedure example of a packet process in a router core of a mobile node supporting router according to the present invention;

FIG. 26 is a diagram showing an operation procedure of a location registration by a mobile node in a network composed of general Mobile IPv6 mobile node supporting routers;

FIG. 27 is a diagram showing an operation procedure of a mobile node-addressed packet transfer in a network composed of general Mobile IPv6 mobile node supporting routers;

FIG. 28 is a block diagram showing an arrangement of a prior art mobile node supporting router;

FIG. 29 is a diagram showing an operation procedure of a location registration in a prior art mobile node supporting router;

FIGS. 30A-30C are diagrams showing a binding packet and binding information exchanged by a location registration in a prior art mobile node supporting router;

FIG. 31 is a diagram showing a routing table example used in a general mobile node supporting router;

FIG. 32 is a diagram showing a procedure of a packet transfer in a prior art mobile node supporting router; and

FIGS. 33A and 33B are diagrams showing an arrangement of a mobile node-addressed packet transferred in a general mobile node supporting router.

Throughout the figures, like reference numerals indicate like or corresponding components.

### DESCRIPTION OF THE EMBODIMENTS

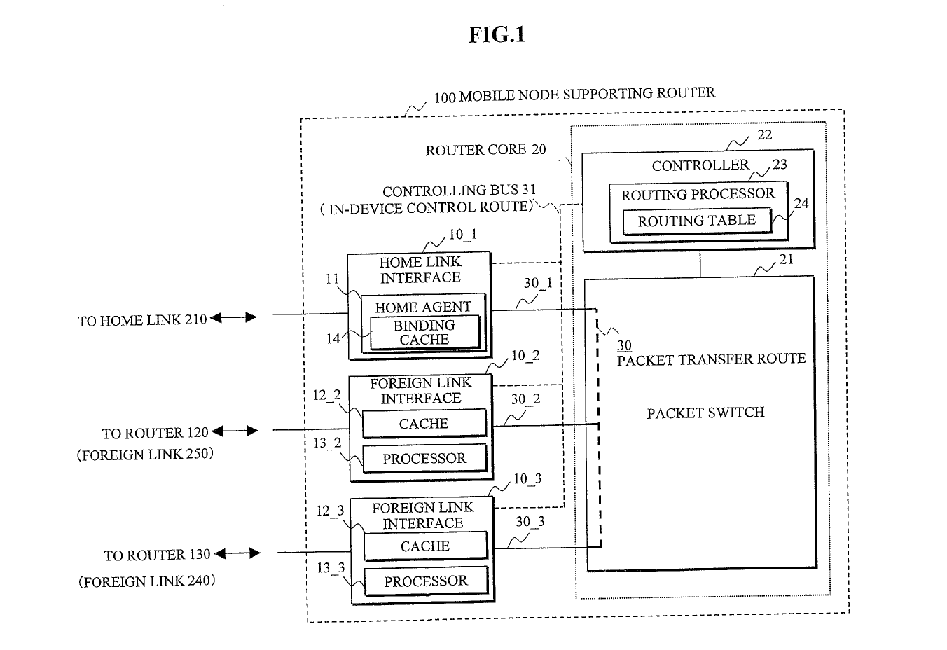

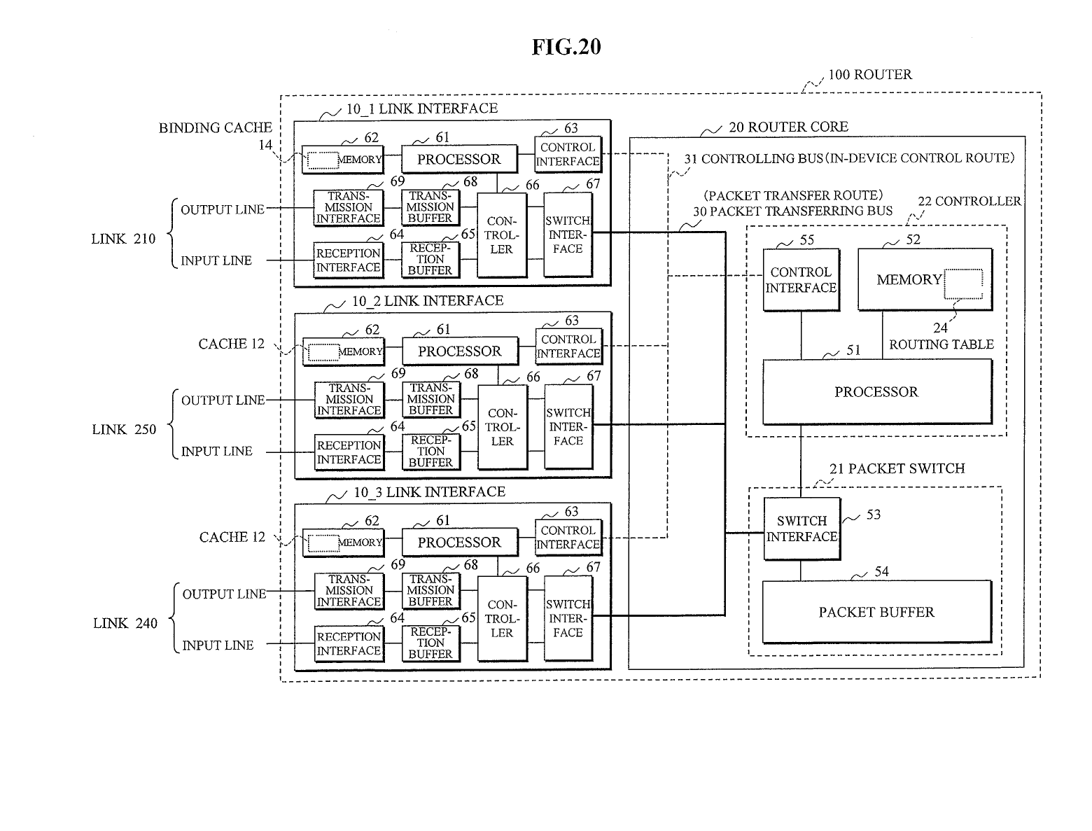

FIG. 20 shows an embodiment of the mobile node supporting router 100 according to the present invention. This example shows a router whose basic arrangement is the same as that of the router 100 shown in FIG. 1.

The router 100 is composed of the link interfaces 10_1-10_3 (occasionally represented by a reference numeral 10) and the router core 20, in which the link interfaces 10_1-10_3 and the router core 20 are mutually connected respectively with the packet transferring bus 30 and the controlling bus 31.

The link interface 10 is composed of a control interface 63 connected to the controlling bus 31, a processor 61 connected to the control interface 63, a memory 62 and a controller 66 connected to the processor 61, a switch interface 67 connected to the packet transferring bus 30, a transmission interface 69 connected to the link, a transmission buffer 68, a reception interface 64 connected to the link and a reception buffer 65.

The reception interface 64, the reception buffer 65, the controller 66, and the interface 67 are connected in cascade in this order, so that the packet received from the link (input line) is provided to the bus 30. Similarly, the interface 67, the controller 66, the transmission buffer 68, and the transmission interface 69 are connected in cascade in this order, so that the packet (transmission frame) is transmitted from the bus 30 to the link (output line).

The router core 20 composed of a processor 51, a memory 52, a control interface 55, and a switch interface 53 connected to the processor 51, and a packet buffer 54 connected to the interface 53. The interfaces 53 and 55 are respectively connected to the buses 30 and 31.

The basic operations of the components of the link interface 10 and the router core 20 will now be described.

(1) Link Interface 10

Processor 61:

The processor 61 executes its program, and realizes functions such as a control of function blocks in the link interface 10, a cooperation with the router core 20, an analysis of a classification of a transmission/reception packet, a generation/update/deletion/retrieval of the cache, a generation of the message, an encapsulation, and a mobile IP message process (in case of home agent).

Memory 62:

The memory 62 stores the program executed at the processor 61. Also, the generated binding information (binding cache) is held.

Control Interface 63:

In order to set and acquire the information from the router core 20, and notify the information to the router core 20 based on the instructions of the processor 61, the control interface 63 exchanges control signals with the router core 20 and another link interface 10 through the controlling bus 31.

Reception Interface 64:

The reception interface 64 receives a transmission frame from the input line to be converted into a packet. The normality confirmation of the frame or the like is performed.

Reception Buffer 65:

The reception buffer 65 temporarily stores the reception packet from the reception interface 64, so that the stored packet is inputted to the router core 20 through the interface 67 and the bus 30.

Transmission Buffer 68:

The transmission buffer 68 temporarily stores the transmission packet outputted from the router core 20 through the bus 30 and the interface 67.

Transmission Interface 69:

The transmission interface 69 converts the transmission packet from the transmission buffer 68 into the transmission frame to be transmitted to the output line.

Controller 66:

The controller 66 controls the reception buffer 65, the transmission buffer 68, the switch interface 67 and the like based on the instructions from the processor 61, and executes operations of the input/output of the packet stored in the reception buffer 65 and the transmission buffer 68, the process of inputting the message generated by the processor 61 to the router core 20, and the like.

Switch Interface 67:

The switch interface 67 inputs/outputs the packet to/from the router core 20 through the packet transferring bus 30.

(2) Router Core 20

Processor 51:

The processor 51 executes the program, and achieves, based on setting information (input node and the like being not shown) by a maintenance person, the functions as follows; setting of information to the router core 20 and the link interfaces 10, a monitor and a control of the link interfaces 10 through the control interface 55 and the controlling bus 31, an execution of various protocols (routing protocol, etc.), a packet routing process, a control of inputting/outputting the packet to/from the link interfaces 10 through the packet transferring bus 30, and the like.

Memory 52:

The memory 52 stores the program executed at the processor 51. Also, the setting information by the maintenance person, the routing table 24, and the like are held.

Control Interface 55:

The control interface 55 exchanges the control signals with the link interfaces 10 through the controlling bus 31 based on the instructions of the processor 51, thereby setting and notifying the information to the link interfaces 10, and acquiring the information from the link interfaces 10.

Switch Interface 53:

The switch interface 53 inputs/outputs the packet to/from the link interfaces 10 through the packet transferring bus 30, and performs a packet transmission between the link interfaces 10.

Packet Buffer 54:

The packet buffer 54 temporarily stores the packet transmitted between the link interfaces 10 through the packet transferring bus 30.

The cache 12, the binding cache 14, the packet switch 21, the controller 22, and the routing table 24 shown by the dotted lines in FIG. 20 respectively indicate the portions which serve the same functions as those of the caches 12_2 and 12_3, the binding cache 14, the packet switch 21, the controller 22, and the routing table 24 shown in FIG. 1.

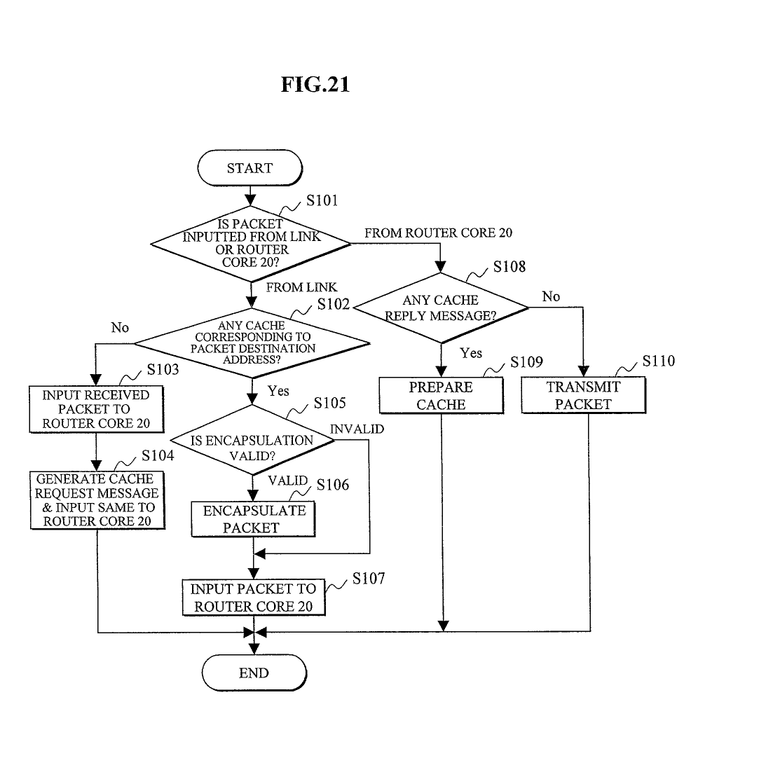

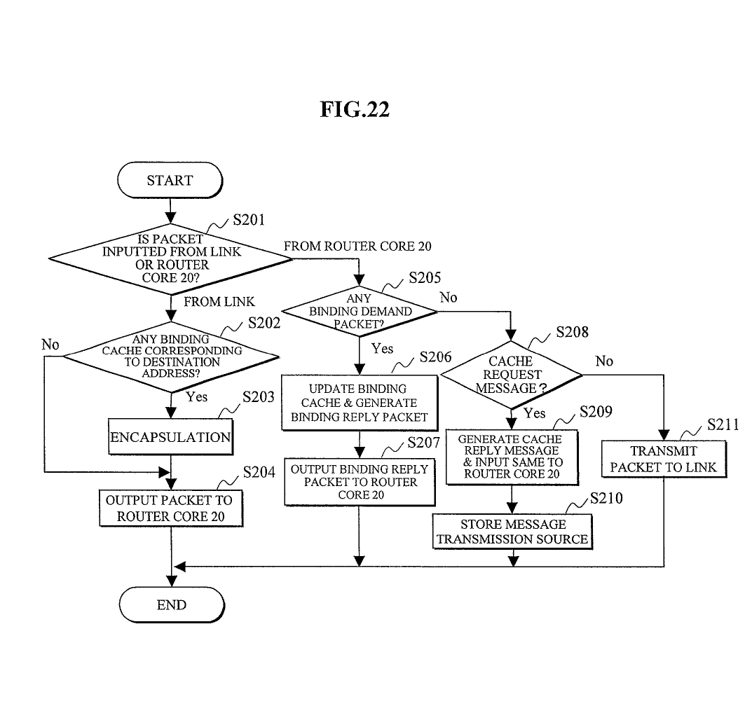

FIG. 21 shows an embodiment of a procedure (1) of a packet reception process at the foreign link interface (see interfaces 10_2 and 10_3 in FIG. 1) of the mobile node supporting router 100 according to the present invention shown in FIG. 20. FIG. 22 shows an embodiment of a procedure (1) of a packet reception process at the home link interface (see interface 10_1 in FIG. 1).

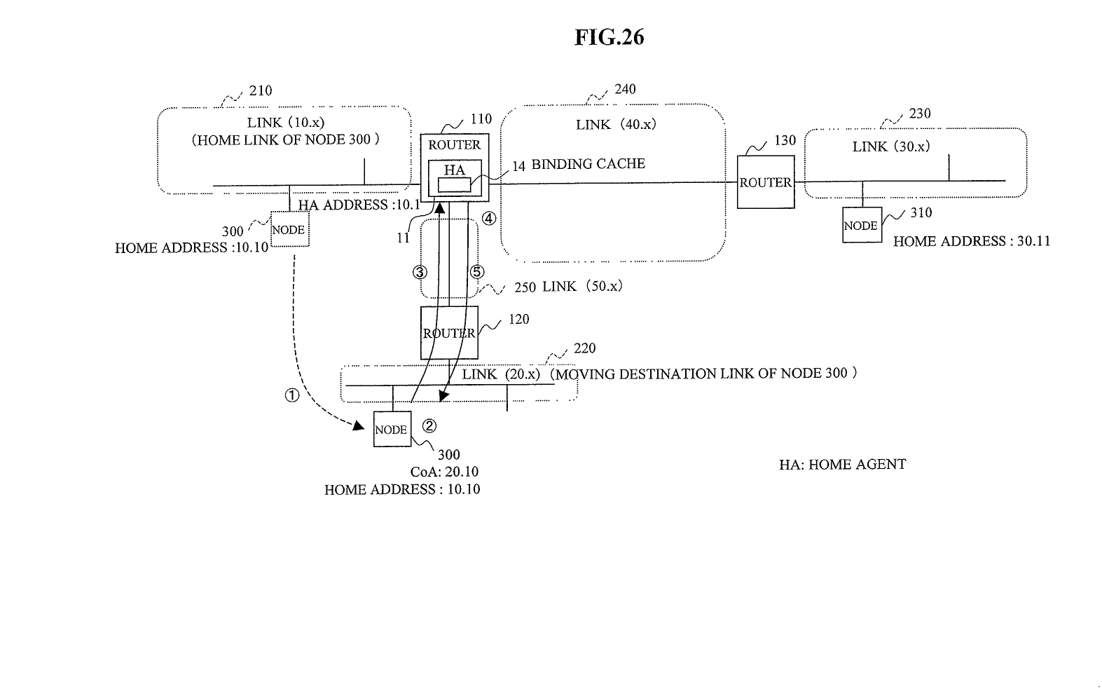

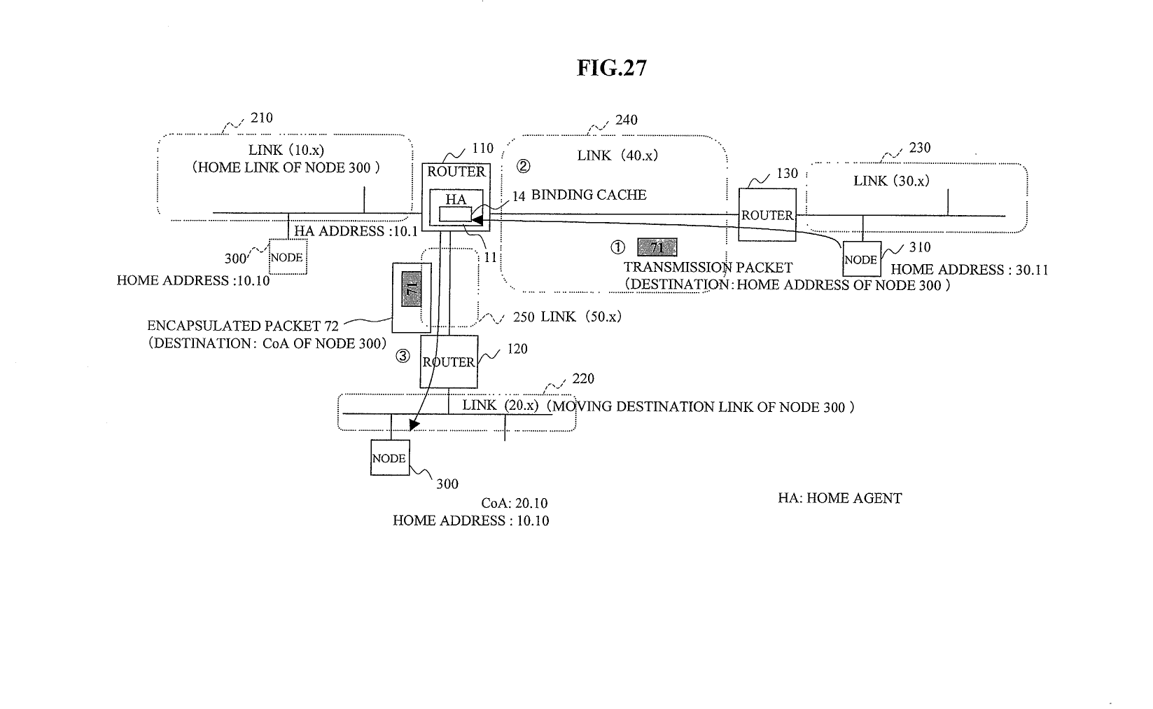

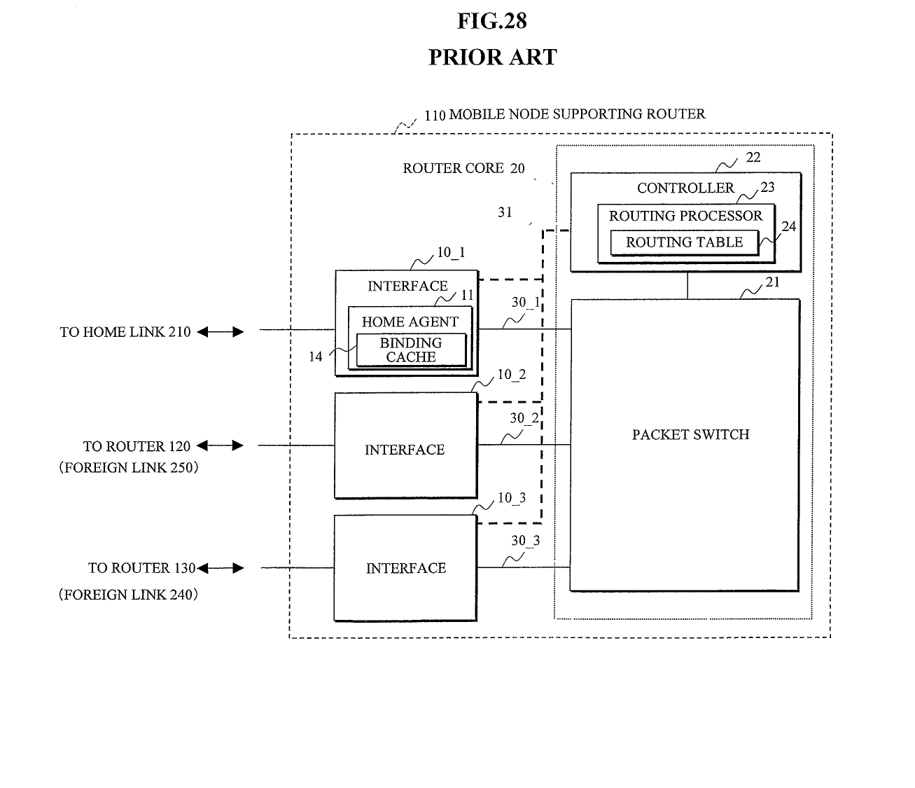

In this packet reception process procedure (1), the prior art routers 110, 120, and 130 in the general Internet network shown in FIG. 26 are replaced with the router 100 of the present invention shown in FIG. 20, and the following operations will be performed.

Link Interface 10

It is supposed that the interface 10_1 shown in FIG. 20 is the home link interface on the mobile node 300 and the interfaces 10_2 and 10_3 are the foreign link interfaces in the same way as the interfaces 10_110_3 10_3 shown in FIG. 1.

Transfer Process of Mobile Node 300-Addressed Packet:

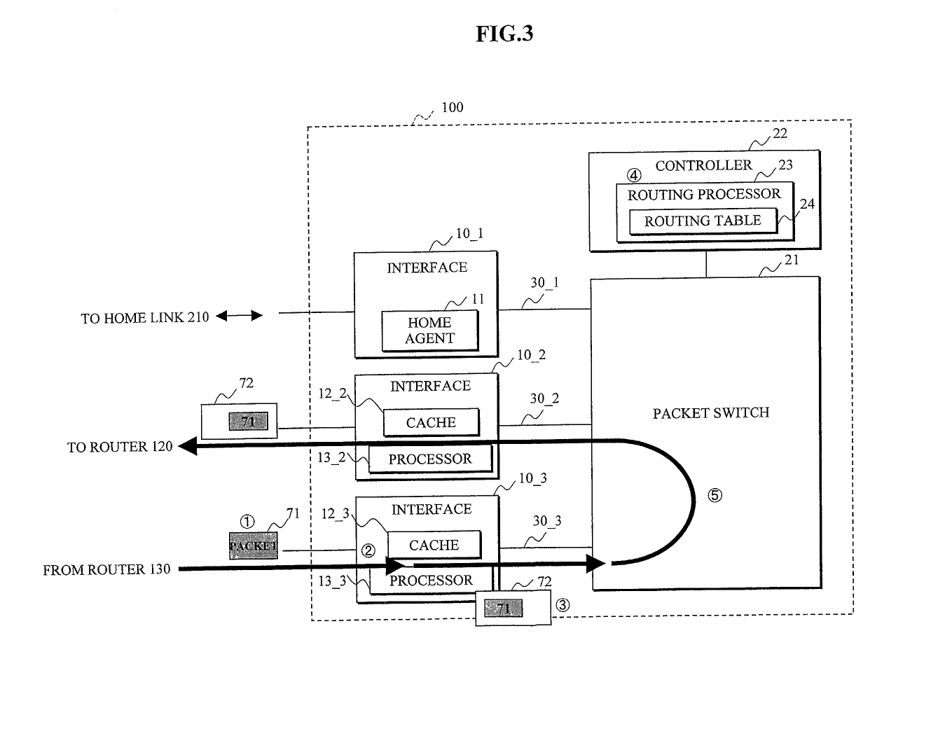

The packet transfer process based on the operation principle (1) of the present invention shown in FIG. 3.

Location Registration Process Procedure from Mobile Node 300 to Home Agent:

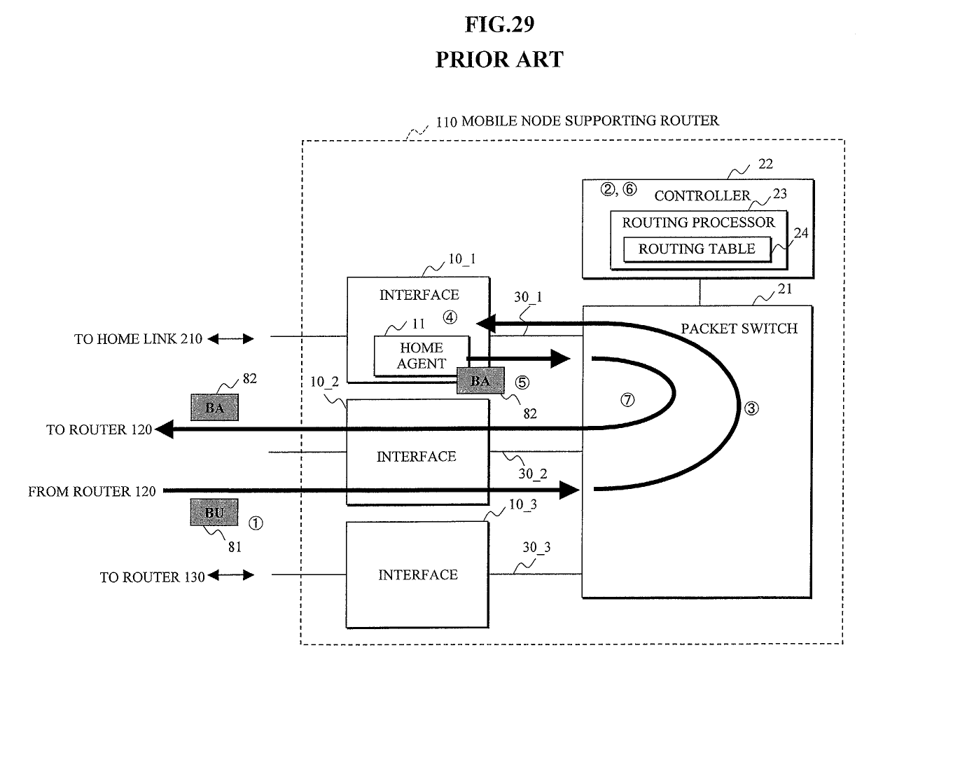

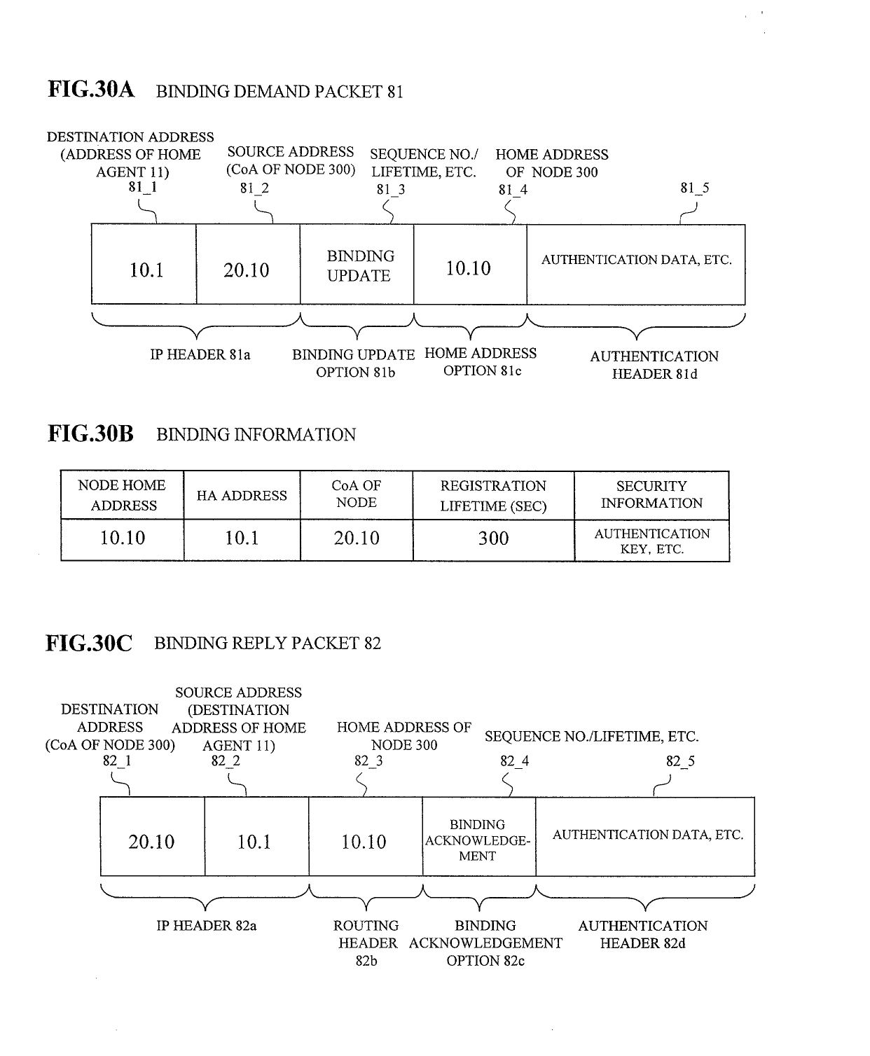

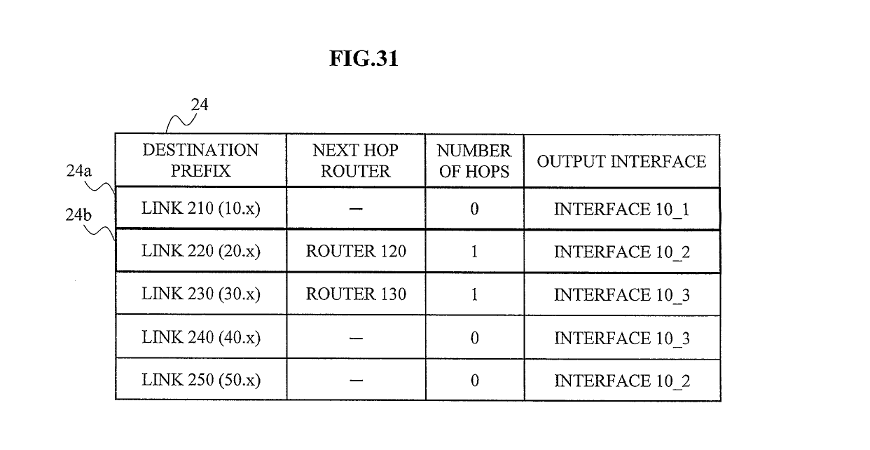

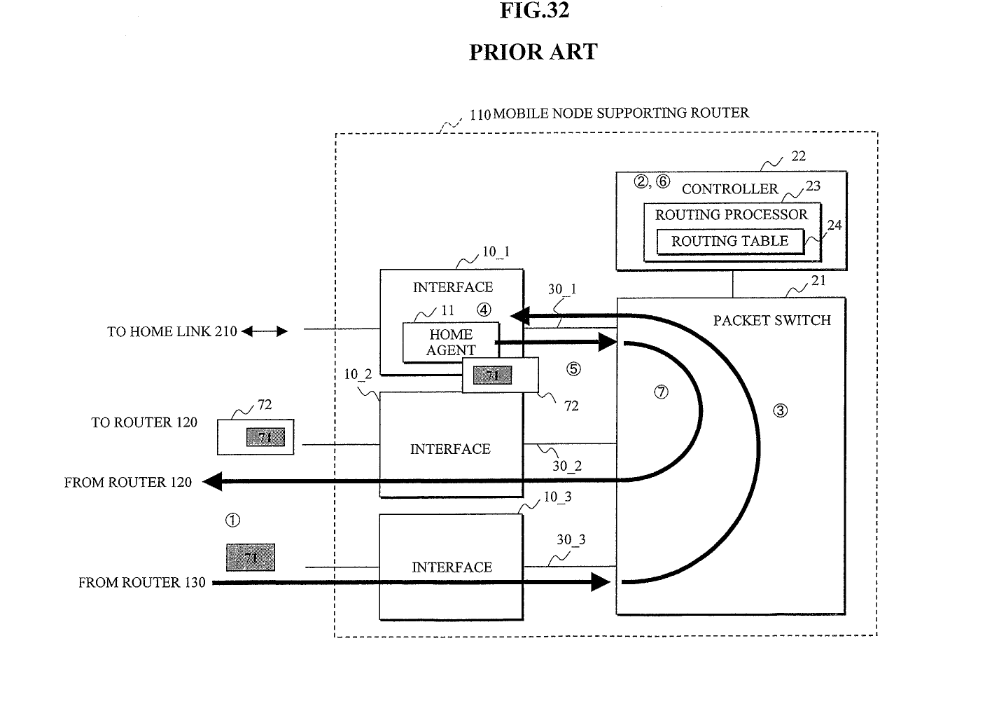

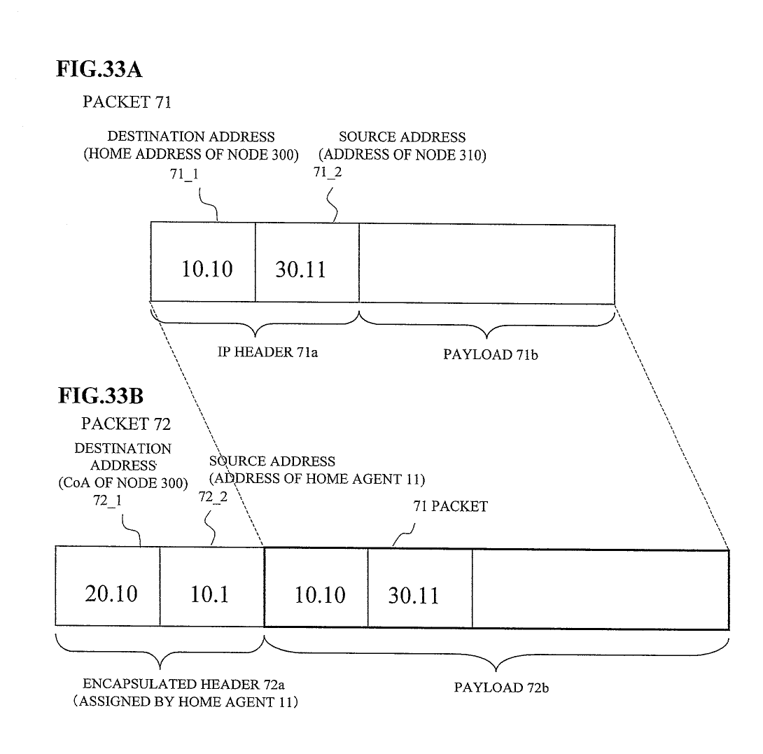

A prior art location registration process procedure shown in FIG. 29.

Information Acquisition Process Procedure of Cache at Foreign Link Interface:

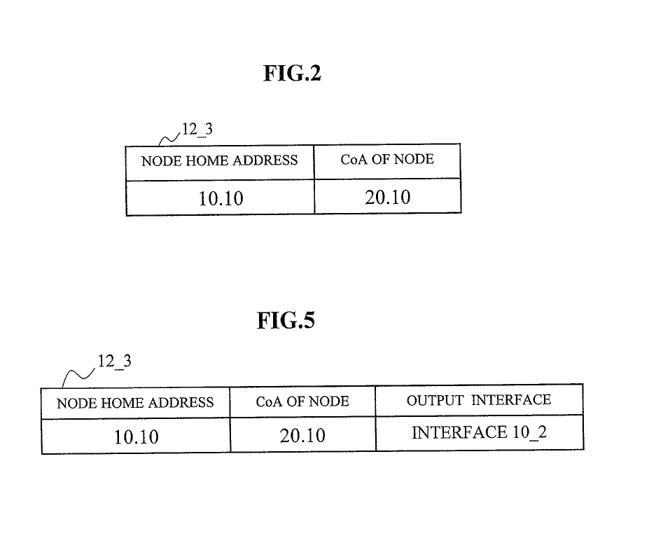

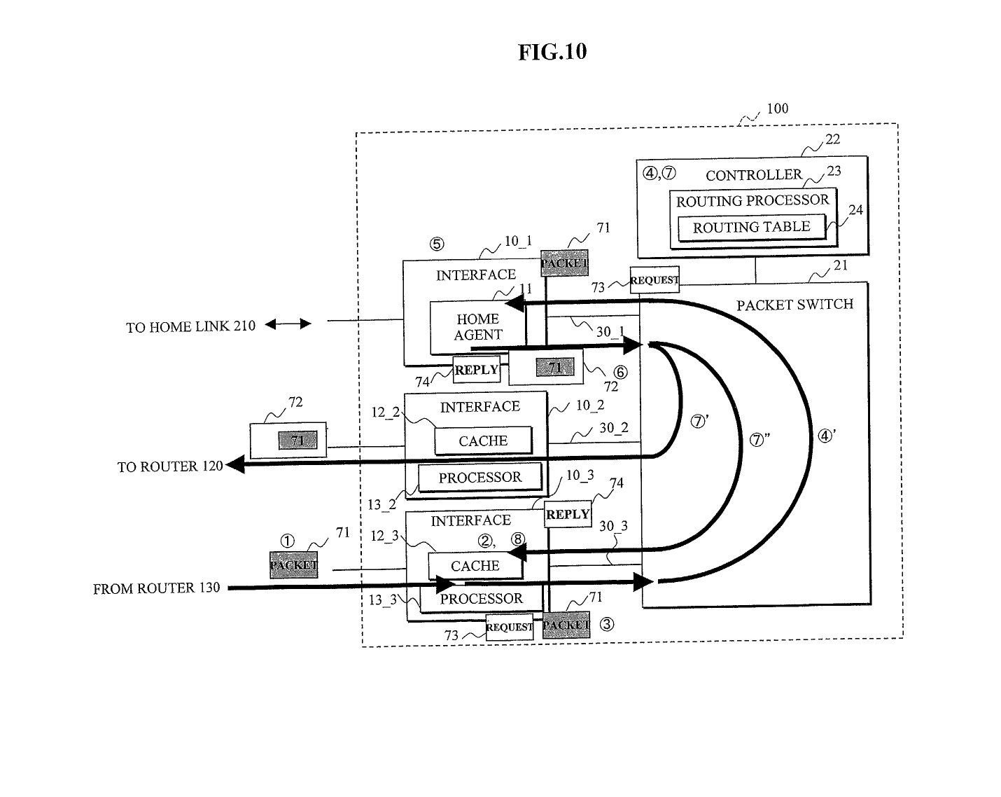

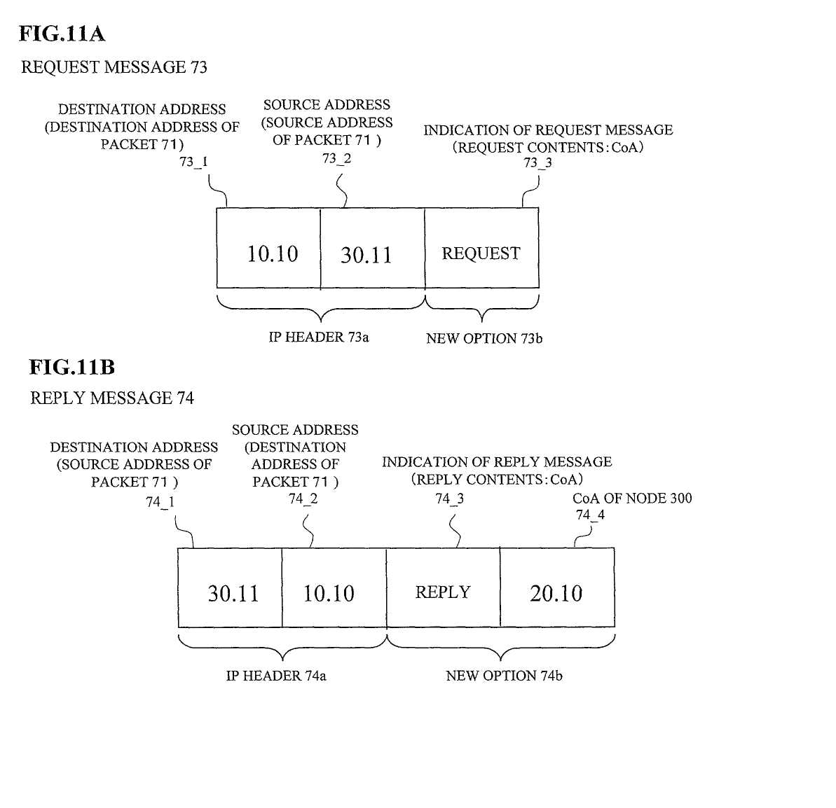

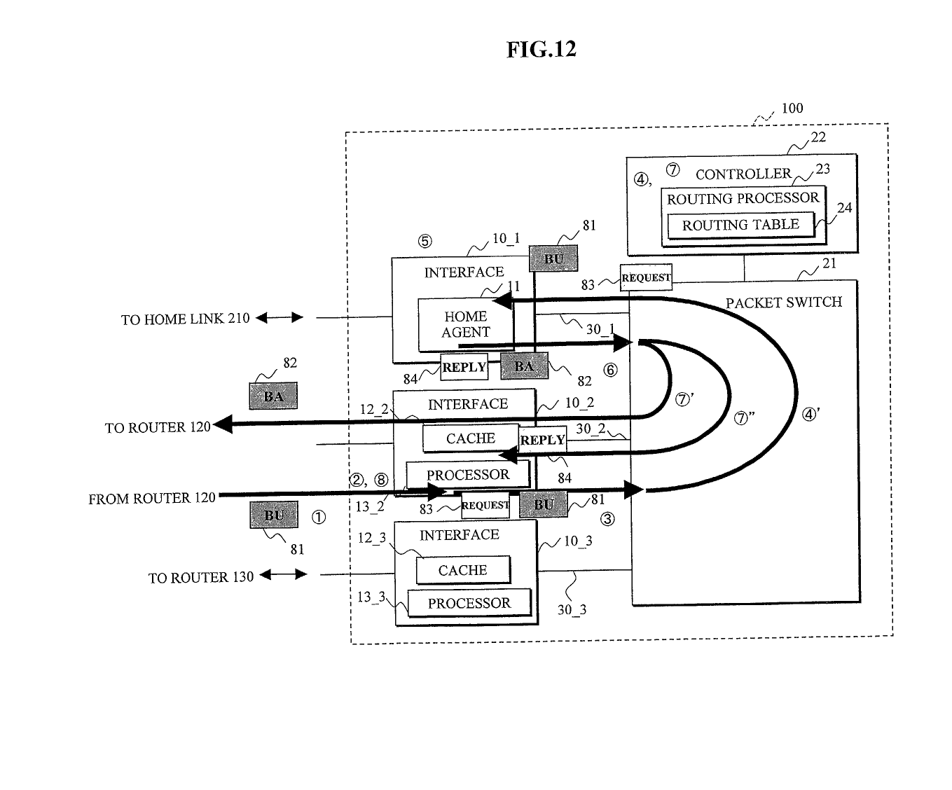

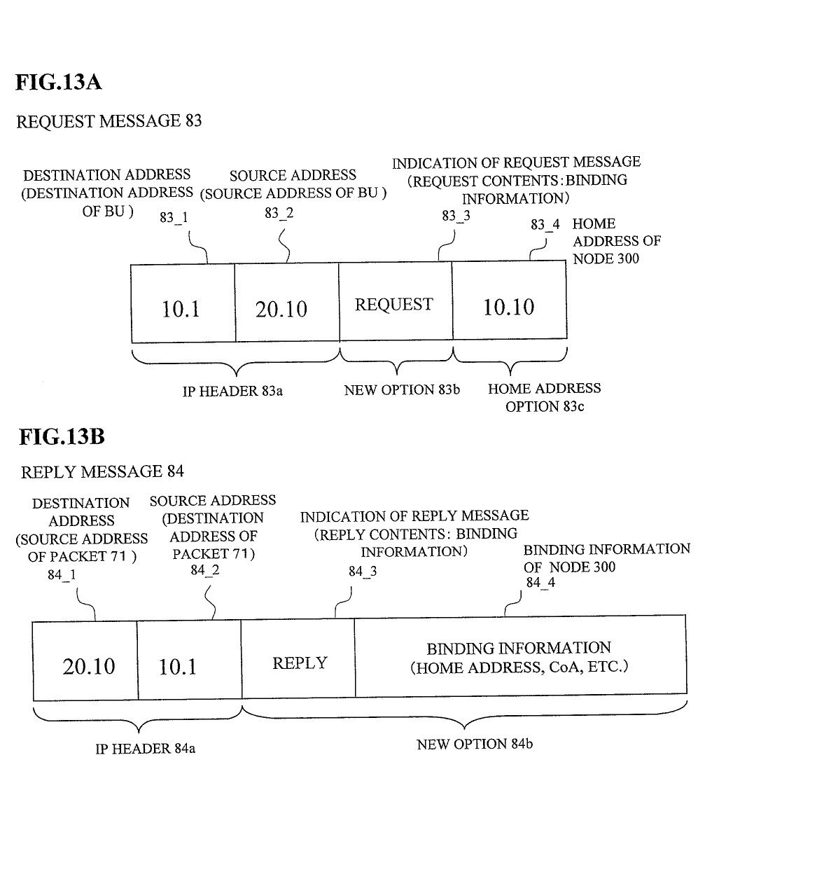

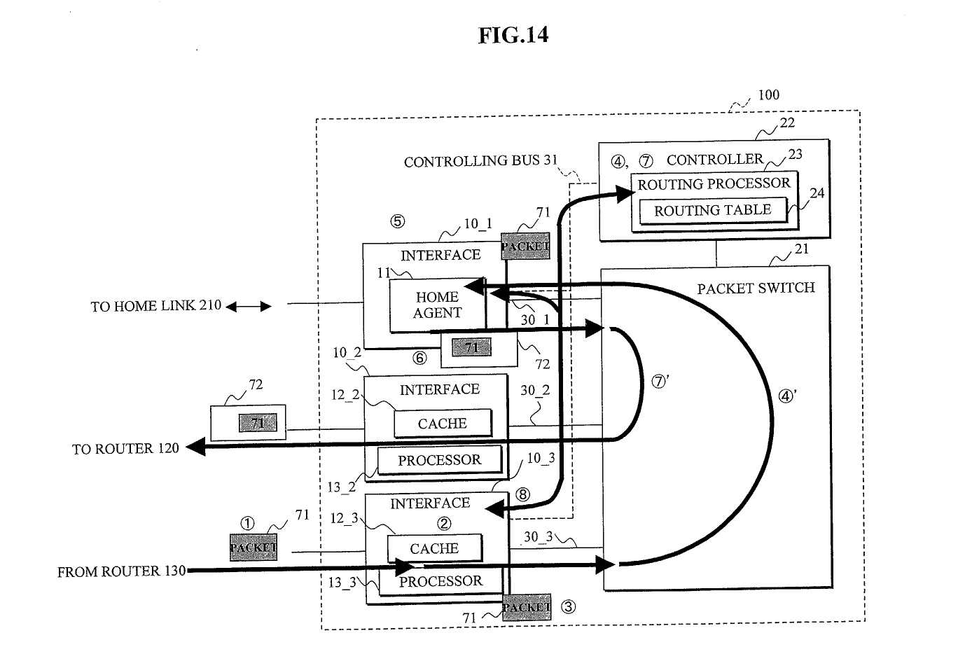

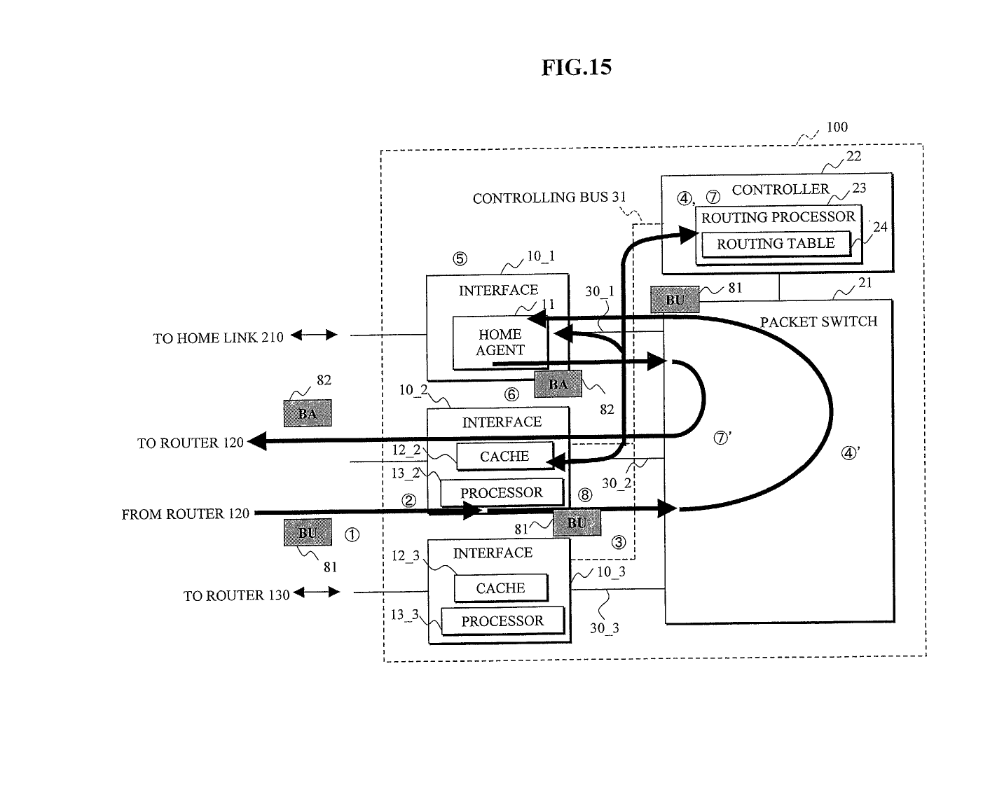

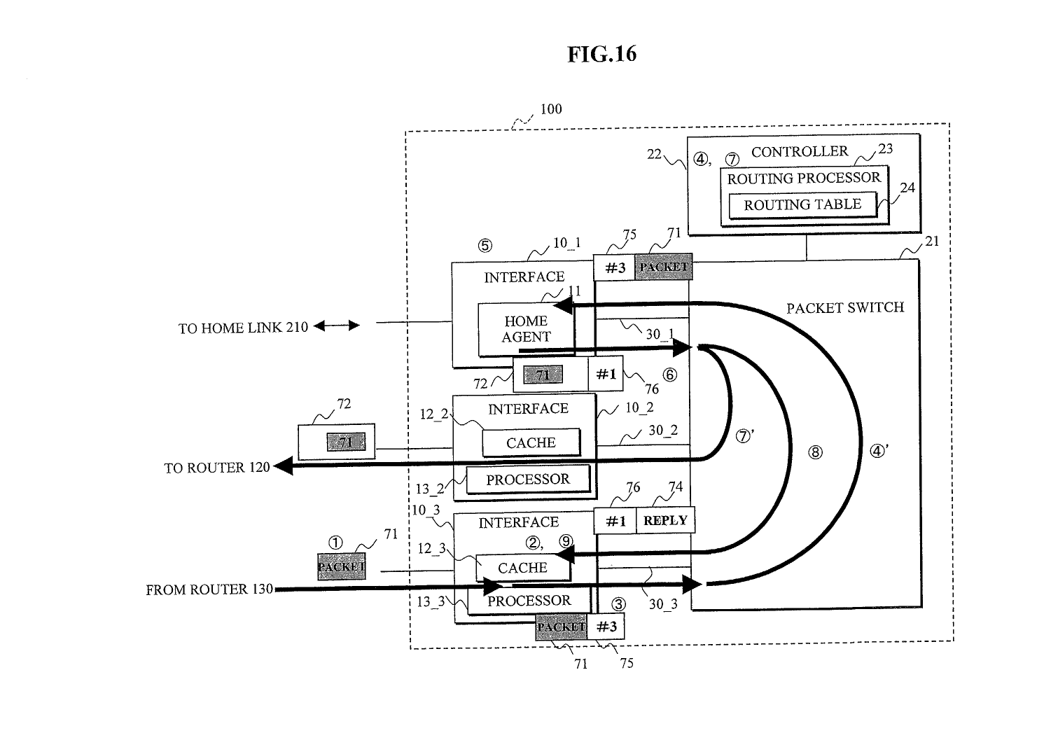

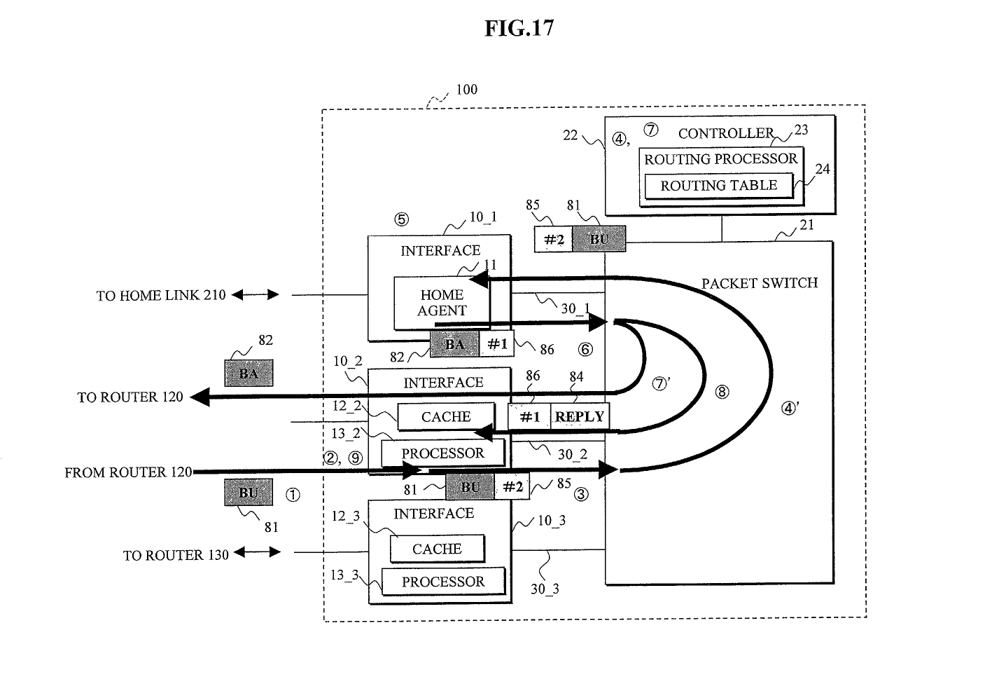

The process procedure of the cache information acquisition based on the operation principle (5) of the present invention shown in FIG. 10. It is to be noted that the encapsulating cache 12 in FIG. 20 is supposed to store the binding information shown in FIG. 2.

Packet Reception Process Procedure (1) at Foreign Link Interface

The packet reception process procedure (1) at the foreign link interface will now be described based on FIG. 21. It is to be noted that this process corresponds to the process performed by e.g. the processor 13_3 in FIG. 10.

Steps S101-S104 in FIG. 21:

In case the packet 71 is inputted from the link, and the binding information corresponding to the destination address=“10.10” of the packet is not stored in the cache 12 (there is no cache), the foreign link interface 10 provides the reception packet 71 to the router core 20 (packet switch 21) and generates the cache request message 73 to be inputted to the router core 20 (see \mathring{1}-\mathring{3} in FIG. 10).

Steps S102, S105-S107:

In case the binding information corresponding to the destination address of the packet 71 inputted from the link is stored in the cache 12 (there is a cache) and a packet encapsulation is valid, the packet 71 is encapsulated so that the encapsulated packet 72 is inputted to the router core 20 (see \mathring{1}-\mathring{3} in FIG. 3). It is to be noted that the setting of valid/invalid of the encapsulation of the packet is determined by e.g. the maintenance person. If the setting is found valid, the router 100 encapsulates the packet, but otherwise does not encapsulate the packet.

Steps S105 and S107:

When the encapsulation of the packet is invalid, the packet is inputted to the router core 20 without encapsulation.

Steps S101, S108, and S109:

In case the packet inputted from the router core is the cache reply message 74, the cache is prepared. Namely, the binding information included in the reply message 74 is stored in the cache 12 (see \mathring{8} in FIG. 10).

Steps S108 and S110:

In case the packet inputted from the router core is not the cache reply message 74 (in case the packet is the encapsulated one addressed to the mobile node), the packet is transmitted to the link (see \mathring{5} in FIG. 3 or \mathring{7} in FIG. 10).

Packet Reception Process Procedure (1) at Home Link Interface

The packet reception process procedure (1) at the home link interface will now be described referring to FIG. 22. It is to be noted that this process corresponds to the process performed by the processor (not shown) included in the home agent 11 or the interface 10_1 in FIG. 1.

Steps S201-S204:

In the presence of the binding cache corresponding to the destination address of the packet inputted from the link (i.e. in the presence of the binding information corresponding to the destination address at the binding cache 14 (see FIG. 1)), the inputted packet is encapsulated to be outputted to the router core 20 (see \mathring{4}′, \mathring{5}, \mathring{6} in FIG. 10).

This process corresponds to the process of encapsulating and routing the mobile node-addressed packet inputted from the home link.

Steps S202 and S204:

In the absence of the binding information corresponding to the destination address of the packet inputted from the link at the binding cache 14, the packet is inputted to the router core 20 without encapsulation. This process corresponds to the process of routing the node-addressed packet, inputted from the home link and not required to be encapsulated or the binding demand packet from the node.

Steps S201 and S205-S207:

When the packet inputted from the router core 20 is the binding demand packet 81, the binding cache 14 is updated, the binding reply packet 82 is generated, and the generated packet 82 is outputted to the router core 20 (see \mathring{3}-\mathring{5} in FIG. 29). This process corresponds to the location registration at the home agent.

Steps S205 and S208-S210:

In case the packet inputted from the router core 20 is the cache request message 73, the cache reply message 74 is generated, and the generated reply message 74 is outputted to the router core. Also, the request message transmission source is stored (see \mathring{4}′, \mathring{5}, and \mathring{6} in FIG. 10).

Steps S208 and S211:

In case the packet inputted from the router core 20 is not the binding demand packet nor the cache request message, the packet is transmitted to the link. This process is for outputting the home link-routed packet to the home link.

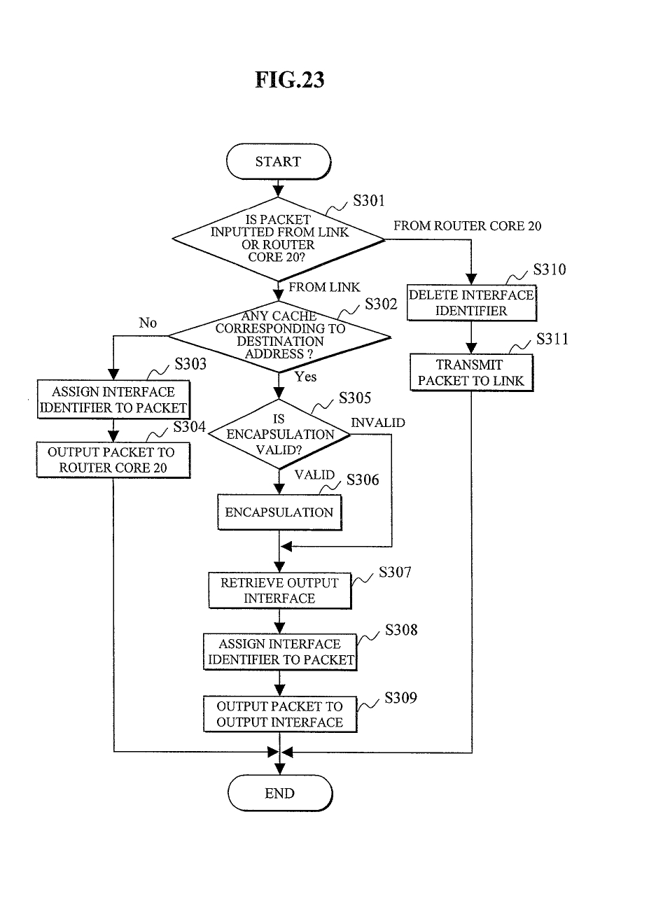

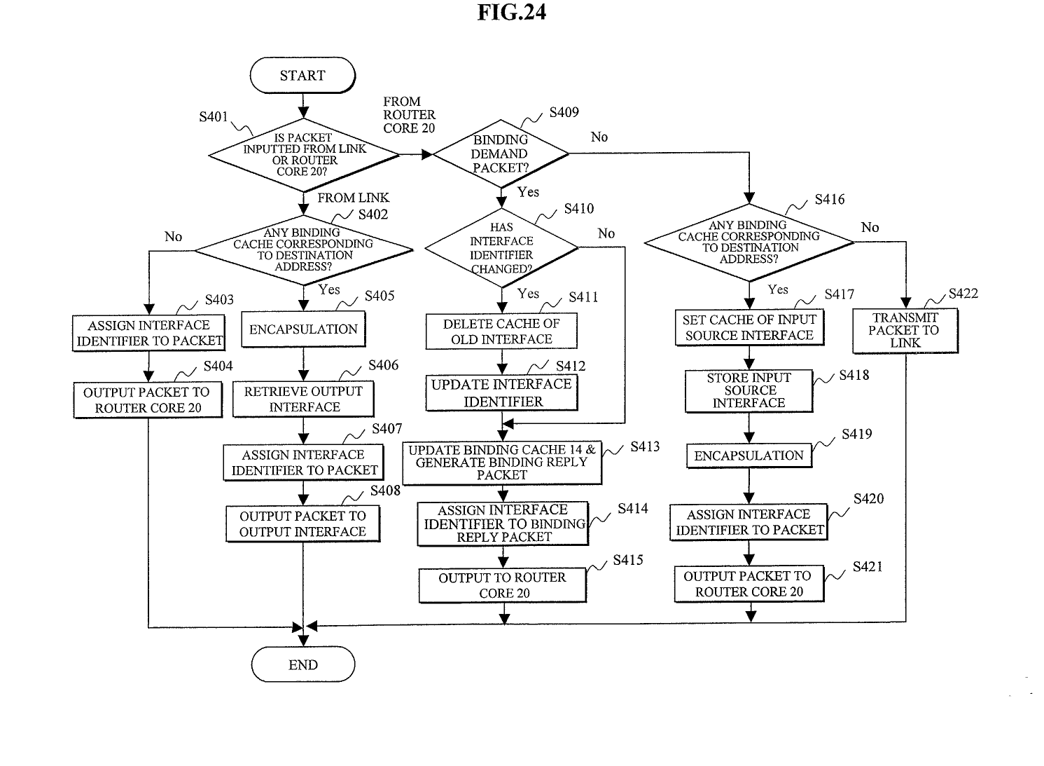

FIG. 23 shows a packet reception process procedure (2) that is another embodiment of the foreign link interface in the mobile node supporting router 100 according to the present invention. FIG. 24 shows a packet reception process procedure (2) that is another embodiment of the home link interface of the mobile node supporting router 100 according to the present invention. These reception process procedures (2) are predicated on the following embodiment:

Transfer Process Procedure of Mobile Node 300-Addressed Packet:

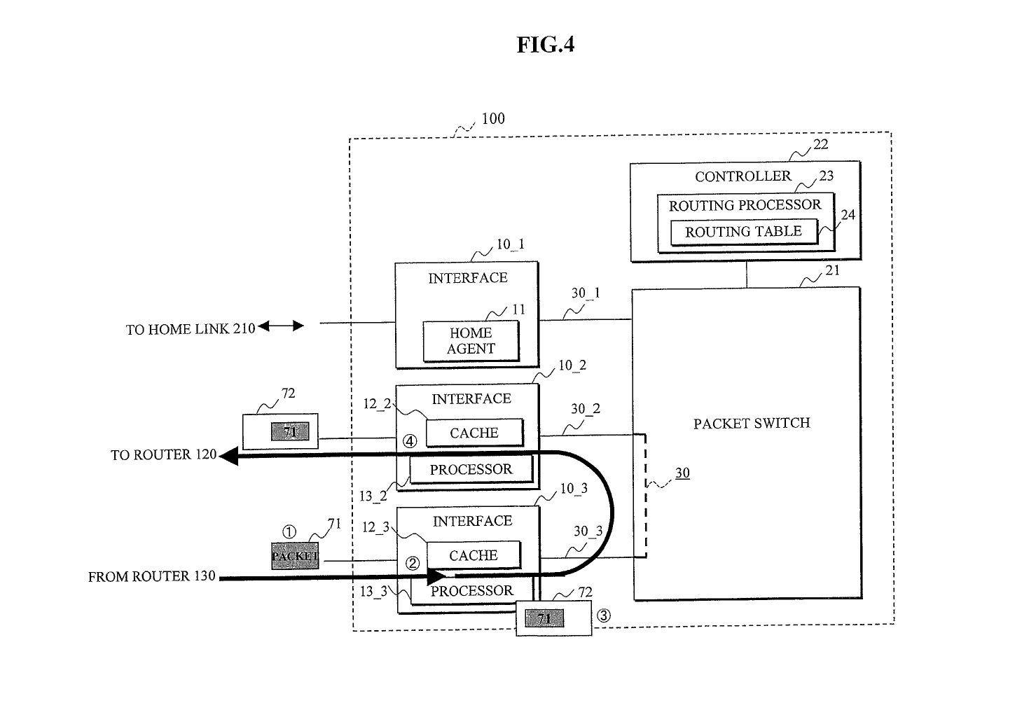

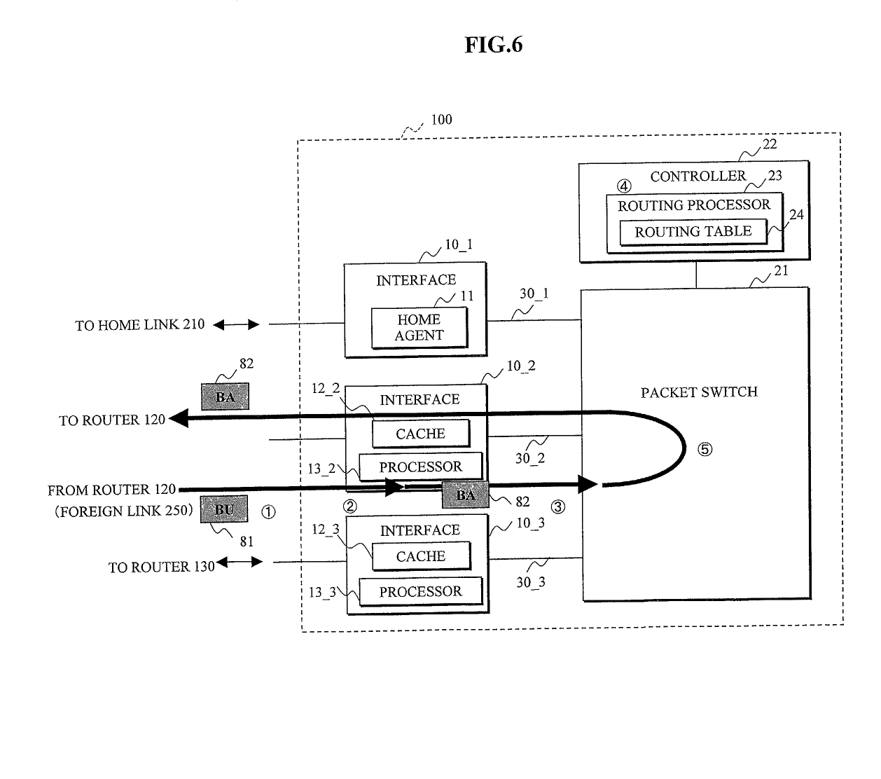

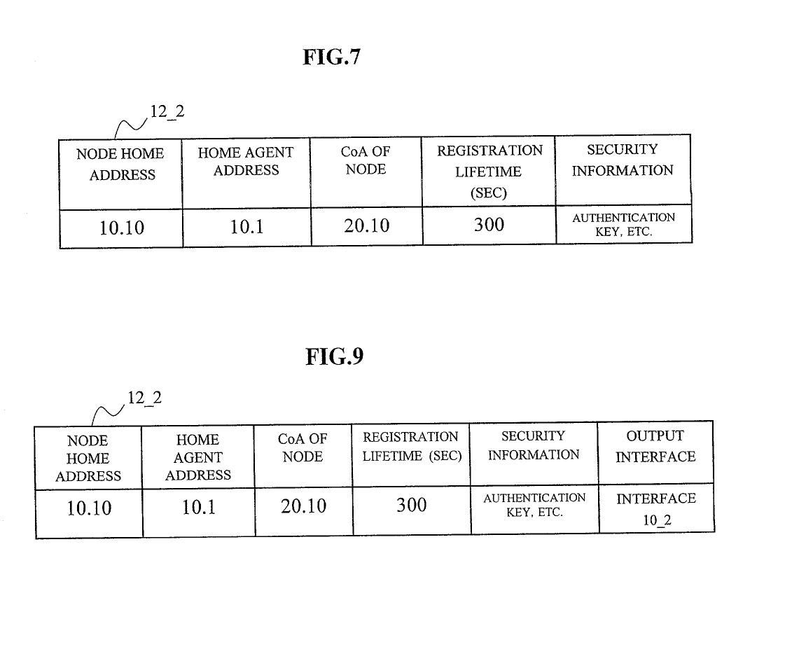

The packet transfer process procedure based on the operation principle (2) of the present invention shown in FIG. 4.

Location Registration Process Procedure from Mobile Node 300 to Home Agent:

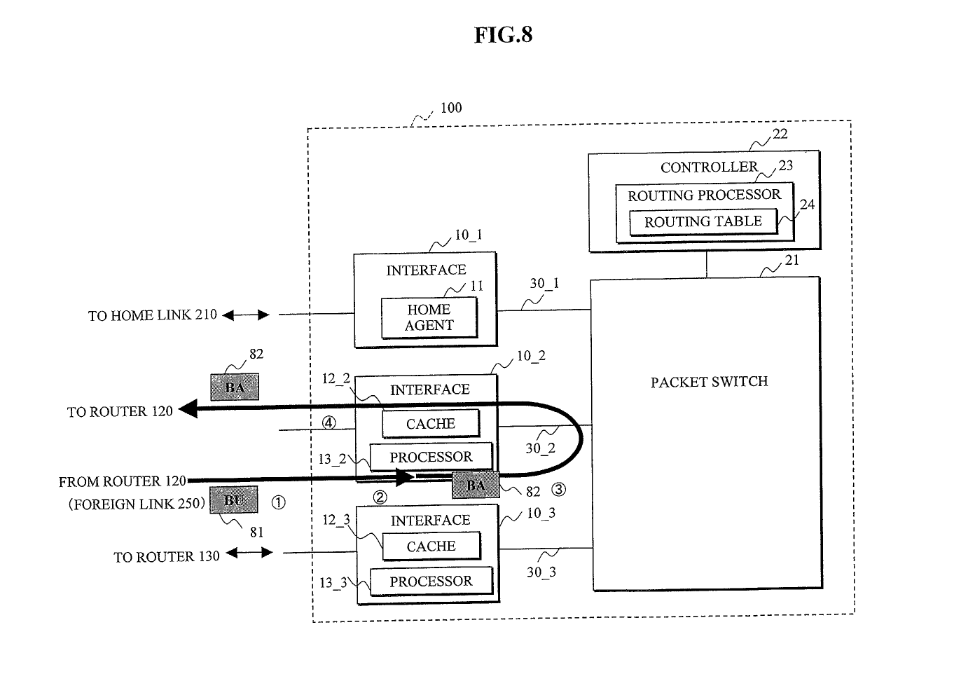

The location registration process procedure based on the operation principle (4) of the present invention shown in FIG. 8.

Information Acquisition Process Procedure of Cache at Foreign Link Interface:

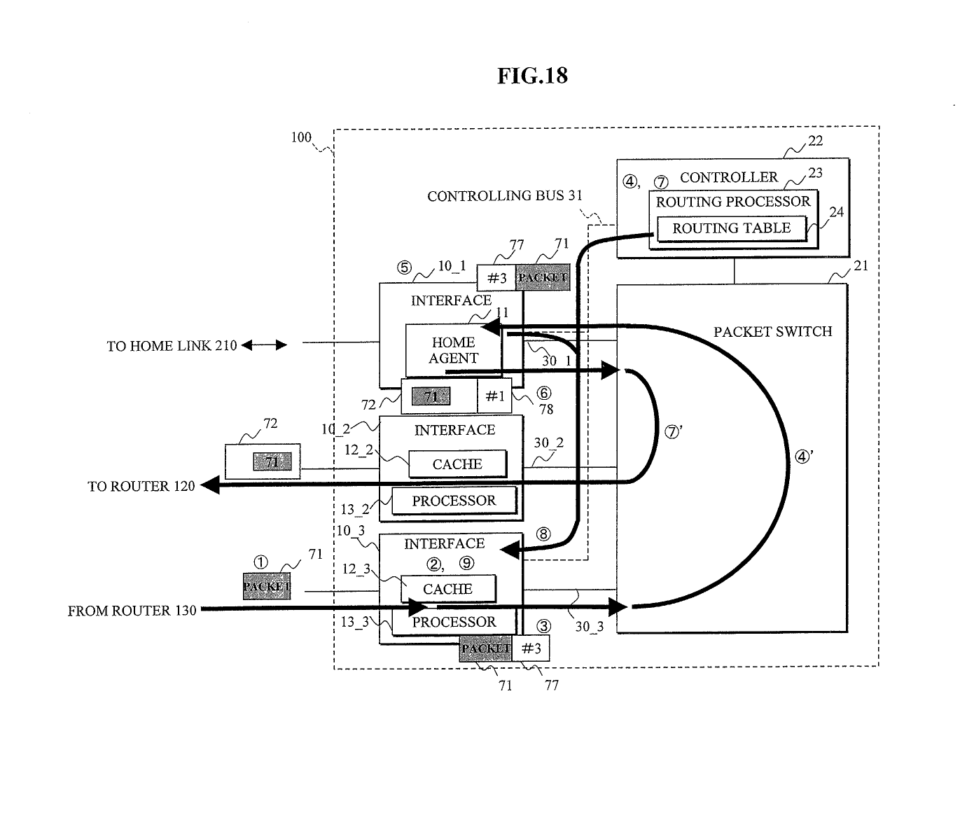

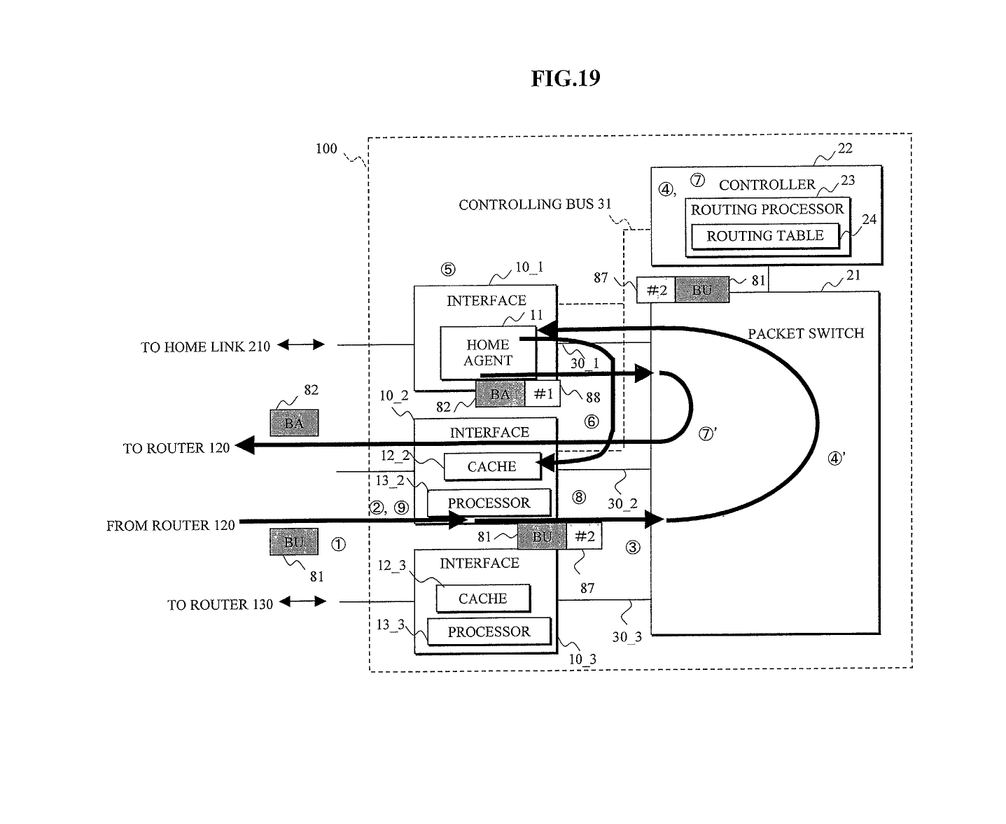

The cache information acquisition process procedure based on the operation principles (11) and (12) of the present invention respectively shown in FIGS. 18 and 19. It is to be noted that the binding information shown in FIGS. 5 and 9 is stored in the cache in this procedure.

Packet Reception Process Procedure (2) at Foreign Link Interface

The packet reception process procedure (2) at the foreign link interface will now be described referring to FIG. 23.

Steps S301-S304:

In the absence of the cache corresponding to the destination address of the packet inputted from the link, the interface identifier of the packet is assigned to the packet to be outputted to the router core (see \mathring{1}-\mathring{3} in FIG. 18, or \mathring{1}-\mathring{3} in FIG. 19).

Steps S302, and S305-S309:

In the presence of the binding information corresponding to the destination address of the packet inputted from the link is in the cache 12 (there is a cache), and if the encapsulation is valid, the packet is encapsulated, the output interface is detected from the cache (see FIGS. 5 and 9), and the packet is outputted to the output interface through the control route 31 after assigning the identifier to the encapsulated packet (see \mathring{1}-\mathring{3} in FIG. 4).

Steps S305, and S307-S309:

If the encapsulation is invalid, the output interface is detected from the cache (see FIGS. 5 and 9), and the packet is outputted to the output interface through the control route 31 without encapsulating the packet after assigning the identifier.

Steps S301, S310, and S311:

The interface identifier is deleted from the packet received from the router core 20 to be transmitted to the link (see \mathring{7}′ in FIGS. 18 and 19).

Packet Reception Process Procedure (2) at the Home Link Interface

The packet reception process procedure (2) at the home link interface will now be described referring to FIG. 24.

Steps S401-S404:

In the absence of the binding information corresponding to the destination address of the packet received from the link at the binding cache 14, the interface identifier is assigned to the packet to be outputted to the router core 20.

Steps S401, S402, and S405-S408:

In the presence of the binding cache 14 (see FIG. 5) corresponding to the destination address of the packet received from the link, the packet is encapsulated, the output interface is retrieved from the cache 14, so that the packet is outputted to the output interface after assigning the identifier of the retrieved interface to the packet.

Steps S401, and S409-S415:

In case the interface identifier of the binding demand packet 81 received from the router core 20 has changed, the update of the interface identifier is performed after deleting the cache of the old interface. The binding cache 14 is updated and the binding reply packet 82 is generated, so that the packet is outputted to the router core after assigning the identifier of the output interface to the binding reply packet 82 (see \mathring{4}′, \mathring{5}, \mathring{6}, and \mathring{7}′ in FIG. 19).

Steps S410 and S413-S415:

In case the interface identifier of the binding demand packet 81 received from the router core 20 has not changed, the binding cache 14 is updated, the binding reply packet 82 is generated, so that the packet is outputted to the router core after assigning the identifier of the output interface to the generated binding reply packet 82 (see \mathring{4}′, \mathring{5}, \mathring{6}, and \mathring{7}′ in FIG. 19).

Steps S401, S409, and S416-S421:

In case the packet received from the router core 20 is not the binding demand packet 81, and in the presence of the destination address of the packet in the binding cache 14, the cache of the source interface is set so that the source interface is stored. After encapsulating the packet and assigning the interface identifier, the packet is outputted to the router core (see \mathring{4}′ \mathring{5}, and \mathring{6} in FIG. 18).

Steps S416 and S422:

If the packet received from the router core 20 is not the binding demand packet, and in the absence of the destination address of the packet in the binding cache 14, the packet is transmitted to the link.

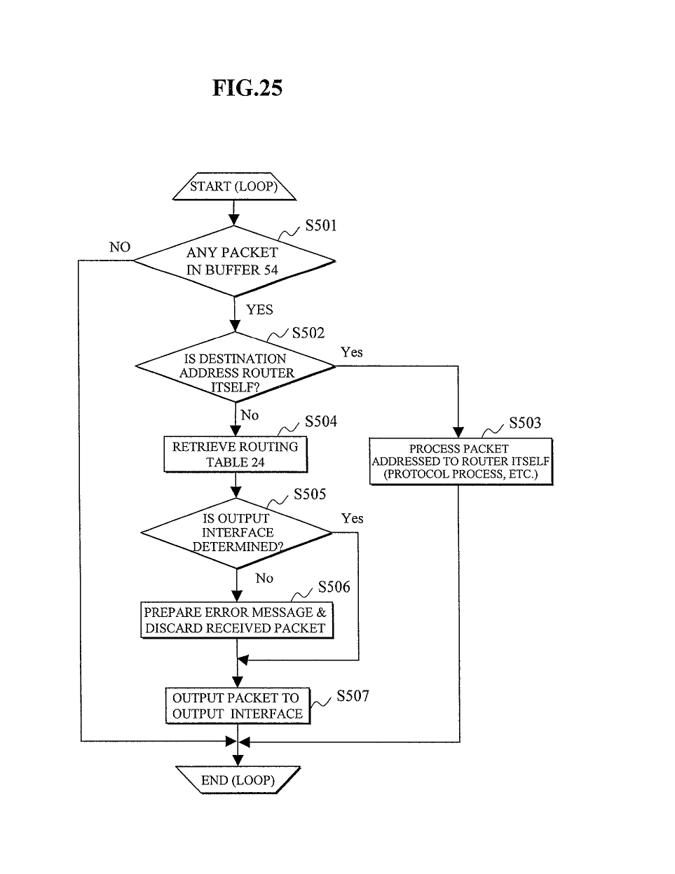

Packet process procedure at router core 20 FIG. 25 shows an embodiment of the packet process procedure at the router core 20 of the mobile node supporting router 100 according to the present invention shown in FIG. 20. This process is related to the “packet transfer route” and the router core 20 repeatedly executes the packet process procedure.

Step S501:

If the packet is not stored in the packet buffer 54, it is not necessary to perform switching (routing) process or the like to the packet so that the loop is ended. The process is returned to step S501 to repeat the loop.

Steps S501-S503:

If the packet is stored in the packet buffer 54 and the destination address of the packet is the router itself, the packet process (protocol process or the like) addressed to the router itself is executed.

Steps S501, S502, S504, S505, and S507:

When the packet is stored in the packet buffer 54, the destination address of the packet is not the router itself, and the output interface is determined by retrieving the routing table 24, the packet is outputted to the determined output interface.

Steps S505-S507:

If the output interface can not be determined by retrieving the routing table 24, the received packet is discarded, and an error message packet is prepared to be outputted to the output interface corresponding to the source.

As described above, a mobile node supporting router according to the present invention is arranged such that an encapsulating cache stores binding information of a mobile node, and a processor encapsulates a packet addressed to the mobile node with a care-of address included in the binding information at a foreign link interface. Therefore, encapsulation of the packet addressed to the mobile node is performed not through a home agent, thereby enabling an encapsulation time to be shortened.

Also, the processor receives a binding demand packet from the mobile node, and stores the binding information included in the binding demand packet in the encapsulation cache, thereby enabling the encapsulation cache to be updated.

Furthermore, the mobile node supporting router according to the present invention is arranged such that the processor provides a binding reply packet for the binding demand packet to an output interface through a packet transfer route. Therefore, it becomes possible to shorten a mobile IP message process.

Also, the mobile node supporting router according to the present invention is arranged such that the processor provides an encapsulated packet addressed to the mobile node or the binding reply packet to the output interface through an in-device control route different from the packet transfer route. Therefore, the packet is directly provided to the output interface 10_2 not through the packet transfer route, thereby enabling the packet transfer speed to be increased.

Also, the mobile node supporting router according to the present invention is arranged such that the processor acquires the binding information from the home agent through the packet transfer route or the in-device control route, when the processor receives e.g. the packet addressed to the mobile node or the binding demand packet from the mobile node and when the encapsulating cache does not store the binding information of the node which has received. Therefore, it becomes possible for the cache to acquire and store the binding information on the mobile node.

Furthermore, the mobile node supporting router according to the present invention is arranged such that the processor of the foreign link interface exchanges the mobile IP messages instead of the home agent of the mobile node, notifies only the necessary information within the message to the home agent, and the cache stores the binding information of the mobile node included in the message. Therefore, the transmission load of the messages within the router is lightened.

As mentioned above, the cache of the foreign link interface temporarily stores information for encapsulating the packet addressed to the mobile node, information of the routing table generated by the router, the binding information generated based on the binding demand packet transmitted from the node which has moved, or the like.

Also, the processor of the foreign link interface performs the same encapsulation process, routing process (determination of output interface), or exchange process of the mobile IP messages as those of the home agent.

By the router according to the present invention provided with the cache and the processor, the process routes of the encapsulation process within the router, the packet routing process, the packet transfer process, the mobile IP message process, and the like are shortened, thereby enabling the process time to be shortened, so that a route which becomes useless owing to the present invention can be used for transferring other packets, and packet delay and packet discard causing a communication quality deterioration of the node can be avoided.

What we claim is:

1. A mobile node supporting router comprising:
a home link interface connected to a home link of a mobile node; and
a foreign link interface connected to a foreign link of the node;
the foreign link interface having an encapsulating cache for storing binding information of the node and a processor for encapsulating a packet addressed to the node with a care-of address included in the binding information.

2. The mobile node supporting router as claimed in claim 1 wherein the binding information comprises information associating a home address of the node with a care-of address at a time of moving.

3. The mobile node supporting router as claimed in claim 2 wherein the binding information associates an output interface which outputs the encapsulated packet with the care-of address.

4. The mobile node supporting router as claimed in claim 1 wherein the binding information includes a lifetime of the binding information itself.

5. The mobile node supporting router as claimed in claim 1 wherein the processor transmits the encapsulated packet to an output interface through a packet transfer route.

6. The mobile node supporting router as claimed in claim 3 wherein the processor provides the encapsulated packet to the output interface.

7. The mobile node supporting router as claimed in claim 1 wherein when receiving a binding demand packet from the node, the processor stores the binding information included in the binding demand packet in the encapsulating cache.

8. The mobile node supporting router as claimed in claim 7 wherein the processor provides a binding reply packet for the binding demand packet to an output interface through a packet transfer route.

9. The mobile node supporting router as claimed in claim 7 wherein the encapsulating cache stores an output interface for outputting the binding reply packet in association with a care-of address of the node within the binding information, and
the processor provides the binding reply packet to the output interface based on the binding information.

10. The mobile node supporting router as claimed in claim 1 wherein when the encapsulating cache does not store the binding information of the node upon receiving a packet associated with the node, the processor acquires the binding information from a home agent.

11. The mobile node supporting router as claimed in claim 10 wherein the packet associated with the node comprises a packet addressed to the node.

12. The mobile node supporting router as claimed in claim 10 wherein the packet associated with the node comprises a binding demand packet from the node.

13. The mobile node supporting router as claimed in claim 10 wherein the processor notifies the home agent, by a request message, that the processor does not store the binding information.

14. The mobile node supporting router as claimed in claim 10 wherein the processor notifies the home agent, through a packet transfer route by assigning to the packet an identifier of a foreign link interface to which the processor itself belongs, that the processor does not store the binding information.

15. The mobile node supporting router as claimed in claim 10 wherein the processor acquires the binding information from the home agent through an in-device control route.

16. The mobile node supporting router as claimed in claim 10 wherein the processor acquires necessary information from a routing table through an in-device control route.

17. The mobile node supporting router as claimed in claim 10 wherein when receiving a notification that the encapsulating cache does not store the binding information, the home agent notifies necessary information to the processor from a binding cache held by the home agent itself.

18. The mobile node supporting router as claimed in claim 17 wherein the home agent notifies the binding information by a reply message through a packet transfer route.

19. The mobile node supporting router as claimed in claim 17 wherein the home agent notifies the binding information through an in-device control route.

20. The mobile node supporting router as claimed in claim 10 wherein when the notification is performed by an identifier of an output interface, the home agent notifies the binding information to which an identifier of an output interface to which the home agent itself belongs is assigned.

21. The mobile node supporting router as claimed in claim 17 wherein the home agent preliminarily stores a foreign link interface to which the notification has been transmitted, so that upon receiving a binding demand packet from the node, the home agent transmits binding information included in the binding demand packet to the stored foreign link interface.

22. A mobile node supporting router comprising:
a home link interface connected to a home link of a mobile node; and
a foreign link interface connected to a foreign link of the node;
the foreign link interface including a processor for exchanging mobile IP messages instead of a home agent of the node and a cache for storing binding information of the node included in the mobile IP message.

23. The mobile node supporting router as claimed in claim 22 wherein the mobile IP message comprises a binding demand packet received from the node and a binding reply packet which responds to the binding demand packet.

24. The mobile node supporting router as claimed in claim 22 wherein when receiving information necessary for updating binding information which a binding cache of the home agent stores by the mobile IP message, the processor transmits the necessary information to the home agent.

25. The mobile node supporting router as claimed in claim 1 or 22 wherein the home agent is at least either on the home link or included in the home link interface.
